(19) United States
(12) Patent Application Publication
(10) Pub. No.: US 2026/0342131 A1
(43) Pub. Date: Oct. 29, 2026

(54) WIRELESS ENERGY STATE INDICATION REPORTING

(71) Applicant: QUALCOMM Incorporated, San Diego, CA (US)

(72) Inventors: Xiaojie WANG, Hillsborough, NJ (US); Luanxia YANG, Beijing (CN); Xiaoxia ZHANG, San Diego, CA (US); Junyi LI, Greentown, PA (US)

(21) Appl. No.: 19/113,406

(22) PCT Filed: Nov. 11, 2022
(86) PCT No.: PCT/CN2022/131364

§ 371 Date: Mar. 19, 2025

(51) Int. Cl. H02J 50/00; H04W 52/02

(52) U.S. Cl. CPC H02J 50/001; H04W 52/0212

(57) ABSTRACT

Systems and techniques are provided for wireless communications. For example, an energy harvesting device can receive, from a network device, an energy status reporting configuration. The energy harvesting device can receive, from the network device, an input radio frequency (RF) signal. The energy harvesting device can transmit, to the network device, energy status information indicative of energy harvesting associated with the energy harvesting device based on the input RF signal.

### FIELD

Aspects of the present disclosure generally relate to wireless communication. In some implementations, examples are described for wireless energy transfer.

### INTRODUCTION

Wireless communications systems are deployed to provide various telecommunication services, including telephony, video, data, messaging, broadcasts, among others. Wireless communications systems have developed through various generations, including a first-generation analog wireless phone service (1G), a second-generation (2G) digital wireless phone service (including interim 2.5G networks), a third-generation (3G) high speed data, Internet-capable wireless service, a fourth-generation (4G) service (e.g., Long-Term Evolution (LTE), WiMax), and a fifth-generation (5G) service (e.g., New Radio (NR)). There are presently many different types of wireless communications systems in use, including cellular and personal communications service (PCS) systems. Examples of known cellular systems include the cellular Analog Advanced Mobile Phone System (AMPS), and digital cellular systems based on code division multiple access (CDMA), frequency division multiple access (FDMA), time division multiple access (TDMA), the Global System for Mobile communication (GSM), etc.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for performing wireless communication. According to at least one illustrative example, a method of wireless communications performed at an energy harvesting device is provided. The method comprises: receiving, at the energy harvesting device from a network device, an energy status reporting configuration; receiving, at the energy harvesting device from the network device, an input radio frequency (RF) signal; and transmitting, from the energy harvesting device to the network device, energy status information indicative of energy harvesting associated with the energy harvesting device based on the input RF signal.

In another illustrative example, an energy harvesting device for wireless communications is provided. The energy harvesting device comprises at least one memory and at least one processor (e.g., configured in circuitry) coupled to the at least one memory, the at least one processor configured to: receive, from a network device, an energy status reporting configuration; receive, from the network device, an input radio frequency (RF) signal; and transmit, to the network device, energy status information indicative of energy harvesting associated with the energy harvesting device based on the input RF signal.

In another illustrative example, a non-transitory computer-readable medium of an energy harvesting device is provided that has stored thereon instructions that, when executed by one or more processors, cause the one or more processors to: receive, from a network device, an energy status reporting configuration; receive, from the network device, an input radio frequency (RF) signal; and transmit, to the network device, energy status information indicative of energy harvesting associated with the energy harvesting device based on the input RF signal.

In another illustrative example, an energy harvesting device is provided. The energy harvesting device comprises: means for receiving, at the energy harvesting device from a network device, an energy status reporting configuration; means for receiving, at the energy harvesting device from the network device, an input radio frequency (RF) signal; and means for transmitting, from the energy harvesting device to the network device, energy status information indicative of energy harvesting associated with the energy harvesting device based on the input RF signal.

In another illustrative example, a method of wireless communications at a network device is provided. The method comprises: transmitting, to an energy harvesting device an, energy status reporting configuration; transmitting, to the energy harvesting device, an input radio frequency (RF) signal; and receiving, from the energy harvesting device, energy status information indicative of energy harvesting associated with the energy harvesting device based on the input RF signal.

In another illustrative example, a network device for wireless communications is provided. The network device comprises at least one memory and at least one processor (e.g., configured in circuitry) coupled to the at least one memory, the at least one processor configured to: transmit, to an energy harvesting device, an energy status reporting configuration; transmit, to the energy harvesting device, an input radio frequency (RF) signal; and receive, from the energy harvesting device, energy status information indicative of energy harvesting associated with the energy harvesting device based on the input RF signal.

In another illustrative example, a non-transitory computer-readable medium is provided that has stored thereon instructions that, when executed by one or more processors, cause the one or more processors to: transmit, to an energy harvesting device, an energy status reporting configuration; transmit, to the energy harvesting device, an input radio frequency (RF) signal; and receive, from the energy harvesting device, energy status information indicative of energy harvesting associated with the energy harvesting device based on the input RF signal.

In another illustrative example, a network device is provided. The network device comprises: means for transmitting, to an energy harvesting device an, energy status reporting configuration; means for transmitting, to the energy harvesting device, an input radio frequency (RF) signal; and means for receiving, from the energy harvesting device, energy status information indicative of energy harvesting associated with the energy harvesting device based on the input RF signal.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip implementations or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof.

FIG. 1 is a block diagram illustrating an example of a wireless communication network, in accordance with some examples;

FIG. 2 is a diagram illustrating a design of a base station and a User Equipment (UE) device that enable transmission and processing of signals exchanged between the UE and the base station, in accordance with some examples;

FIG. 3 is a diagram illustrating an example of a disaggregated base station, in accordance with some examples;

FIG. 4 is a block diagram illustrating components of a user equipment (UE), in accordance with some examples;

FIG. 5 is a diagram illustrating an example of a radio frequency (RF) energy harvesting device, in accordance with some examples;

FIG. 6 is a diagram illustrating an example of small signal operation of a Schottky diode barrier, in accordance with some examples;

FIG. 7A is a diagram illustrating example energy harvesting characteristics between input power and harvested power, in accordance with some examples;

FIG. 7B is a diagram illustrating an example of energy conversion efficiency associated with different frequencies and input powers, in accordance with some examples;

FIG. 8 is a diagram illustrating examples of periodic and aperiodic Energy State Information (ESI) reporting, in accordance with some examples;

FIG. 9 is a diagram illustrating an example of semi-persistent ESI reporting, in accordance with some examples;

FIG. 10A is a diagram illustrating an example of ESI reporting using dedicated periodic resources, in accordance with some examples;

FIG. 10B is a diagram illustrating an example of ESI reporting using a next available resource, in accordance with some examples;

FIG. 11 is a flow diagram illustrating an example of a process for wireless communications, in accordance with some examples; and

FIG. 12 is a block diagram illustrating an example of a computing system, in accordance with some examples.

FIG. 13 is a diagram illustrating an example of a system for implementing certain aspects of the present technology.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Wireless communication networks can be deployed to provide various communication services, such as voice, video, packet data, messaging, broadcast, any combination thereof, or other communication services. A wireless communication network may support both access links and sidelinks for communication between wireless devices. An access link may refer to any communication link between a client device (e.g., a user equipment (UE), a station (STA), or other client device) and a base station (e.g., a 3GPP gNB for 5G/NR, a 3GPP eNB for 4G/LTE, a Wi-Fi access point (AP), or other base station). For example, an access link may support uplink signaling, downlink signaling, connection procedures, etc. An example of an access link is a Uu link or interface (also referred to as an NR-Uu) between a 3GPP gNB and a UE.

In various wireless communication networks, various client devices can be utilized that may be associated with different signaling and communication needs. For example, as 5G networks expand into industrial verticals and the quantity of deployed Internet-of-Things (IoT) devices grows, network service categories such as enhanced Mobile Broadband (eMBB), Ultra Reliable Low Latency Communications (URLLC), and massive Machine Type Communications (mMTC), etc., may be expanded to better support various IoT devices, which can include passive IoT devices, semi-passive IoT devices, etc.

For example, passive IoT devices and semi-passive IoT devices are relatively low-cost UEs that may be used to implement one or more sensing and communication capabilities in an IoT network or deployment. In some examples, passive and/or semi-passive IoT sensors (e.g., devices) can be used to provide sensing capabilities for various processes and use cases, such as asset management, logistics, warehousing, manufacturing, etc. Passive and semi-passive IoT devices can include one or more sensors, a processor or micro-controller, and an energy harvester for generating electrical power from incident downlink radio frequency (RF) signals received at the passive or semi-passive IoT device.

Based on harvesting energy from incident downlink RF signals (e.g., transmitted by a network device such as a base station, gNB, etc.), energy harvesting devices (e.g., such as passive IoT devices, semi-passive IoT devices, etc.) can be provided without an energy storage element and/or can be provided with a relatively small energy storage element (e.g., battery, capacitor, etc.) Energy harvesting devices can be deployed at large scales, based on the simplification in their manufacture and deployment associated with implementing wireless energy harvesting.

In a wireless communication network environment (e.g., cellular network, etc.), a network device (e.g., such as a base station or gNB, etc.) can be used to transmit downlink RF signals to energy harvesting devices. In one illustrative example, a base station or gNB can read and/or write information stored on energy harvesting IoT devices by transmitting the downlink RF signal. A downlink RF signal can provide energy to an energy harvesting IoT device and can be used as the basis for an information-bearing uplink signal transmitted back to the network device by the energy harvesting IoT device (e.g., based on reflecting or backscattering a portion of the incident downlink RF signal). The base station or gNB can read the reflected signal transmitted by an energy harvesting IoT device to decode the information transmitted by the IoT device (e.g., such as sensor information collected by one or more sensors included in the IoT device, etc.).

In some examples, for a given downlink signal with a given input RF power received at an energy harvesting device, a first portion of the input RF power is provided to the device's energy harvester (e.g., with a percentage being converted to useful electrical power based on the conversion efficiency of the harvester, and the remaining percentage wasted or dissipated as heat, etc.). A remaining, second portion of the input RF power is available for use in the backscattered uplink transmission (e.g., the second portion of the input power is reflected and modulated with the uplink communication).

There is a need to improve an energy conversion efficiency associated with energy harvesting devices (e.g., including passive and semi-passive IoT devices). In some cases, there is a further need to provide a greater communication range associated with passive and/or semi-passive energy harvesting devices (e.g., passive and/or semi-passive IoT devices).

Systems, apparatuses, processes (also referred to as methods), and computer-readable media (collectively referred to as “systems and techniques”) are described herein that can be used to provide improved wireless energy harvesting and/or backscatter modulation-based communications between an energy harvesting device (e.g., passive, semi-passive, or active IoT device, etc.) and a network node or transmitter (e.g., gNB or base station). For example, the systems and techniques described herein can be used to provide optimized or improved wireless energy transfer for an energy harvesting device, based on Energy State Indication (ESI) information and/or an ESI report provided from the energy harvesting device to a corresponding network device (e.g., base station, transmitter, etc.) In some cases, based on receiving the ESI information and/or ESI report from an energy harvesting device, a network device (e.g., also referred to as a “reader” or an “energy transmitter”) can generate a downlink RF signal that is optimized for energy harvesting by the energy harvesting device. For example, the network device can schedule energy transmission to an energy harvesting device based on previously received ESI information associated with the energy harvesting device. In some examples, the network device can schedule energy transmission to the energy harvesting device wherein the scheduled energy transmission utilizes a waveform and/or power that is determined based on the ESI information associated with the energy harvesting device.

In some examples, an energy harvesting device (e.g., a passive IoT device, semi-passive IoT device, active IoT device, etc.) can generate and transmit one or more uplink messages that include ESI information associated with the energy harvesting device. In some cases, the one or more uplink messages can be transmitted in a combined ESI report and/or may be transmitted using one or more ESI reports each including multiple sets or types of ESI information.

In some examples, a given energy harvesting device may be associated with energy harvesting characteristics that are based on a hardware configuration of the given energy harvesting device and/or that are based on the type(s) of hardware component(s) included in the given energy harvesting device. For example, different energy harvesting devices may achieve optimum or maximum energy conversion efficiency at different combinations of input RF power, input waveform center frequency, input waveform shape or type, etc. In some cases, the ESI information and/or ESI report(s) transmitted by an energy harvesting device can be indicative of a conversion efficiency associated with energy harvesting performed by the energy harvesting device for previously received energy transmissions (e.g., previously received energy transmissions from a network device that receives the subsequent ESI information or ESI report(s)). In some cases, the ESI information transmitted by an energy harvesting device can be indicative of the energy conversion efficiency of the energy harvesting device based on one or more (or all) of an input RF signal frequency, an input RF signal power, an incident waveform type, shape, or filtering, etc.

In some examples, the ESI information and/or conversion efficiency of energy transfer (e.g., energy harvesting) performed by the energy harvesting device may be associated with a rectifier included in an energy harvesting device, wherein the rectifier is used by the energy harvesting device to perform energy harvesting. In some cases, a network device receiving ESI information and/or ESI report(s) from an energy harvesting device can schedule energy transmission for low-energy devices based on the received ESI. For example, an energy harvesting device may include one or more batteries or energy storage elements. A low-energy device may be an energy harvesting device with an energy storage element that has a current stored energy below a threshold quantity or percentage. In some examples, a network device may increase or decrease a transmit power (e.g., input power) of an energy signal transmitted to an energy harvesting device, based on ESI information received from the energy harvesting device and indicative of a conversion efficiency of the energy harvesting device at previous transmit powers used by the network device. For example, the network device can increase or decrease transmit power based on received ESI information such that the energy harvesting device can harvest RF energy more efficiently from the energy signal. In some cases, a network device may additionally, or alternatively, adapt the energy signal waveform and/or bandwidth based on received ESI information associated with an energy harvesting device. For example, different energy waveforms may be associated with different conversion efficiencies and/or rectifier performances, based on the type of rectifier included in a given energy harvesting device. Based on the received ESI, the network device can select and utilize an energy waveform that is matched to the rectifier type of a given energy harvesting device.

In some cases, a network device (e.g., base station, gNB, etc.) can configure ESI signaling to be performed by an energy harvesting device. For example, a network device can transmit an ESI configuration to an energy harvesting device, wherein the ESI configuration is indicative of how the energy harvesting device is expected to report the ESI information to the network device. In some cases, the ESI configuration can indicate one or more ESI formats to be used by the energy harvesting device and/or may include one or more indicated resources for performing ESI reporting. In some examples, the one or more indicated resources for performing ESI reporting can include resources for performing Layer One (L1) reporting, Media Access Control (MAC) Control Element (CE) reporting, etc. In some examples, the network device can use the ESI configuration to configure periodic, semi-persistent, and/or aperiodic ESI reporting by an energy harvesting device. In some examples, the network device can configure ESI reporting per band and/or may configured average ESI reporting across multiple bands. In some cases, the ESI configuration can be indicative of one or more (or all) of a latency bound, an ESI measurement window, an ESI periodic timer, etc., that are used by an energy harvesting device to perform ESI reporting to the network device.

Further aspects of the systems and techniques will be described with respect to the figures.

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), aircraft (e.g., an airplane, jet, unmanned aerial vehicle (UAV) or drone, helicopter, airship, glider, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.), and so on.

A network entity can be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, or a forward traffic channel, etc.). The term traffic channel (TCH), as used herein, can refer to either an uplink, reverse or downlink, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (e.g., a network of spatially separated antennas connected to a common source via a transport medium) or a remote radio head (RRH) (e.g., a remote base station connected to a serving base station). Alternatively, the non-co-located physical TRPs may be the serving base station receiving the measurement report from the UE and a neighbor base station whose reference radio frequency (RF) signals (e.g., or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

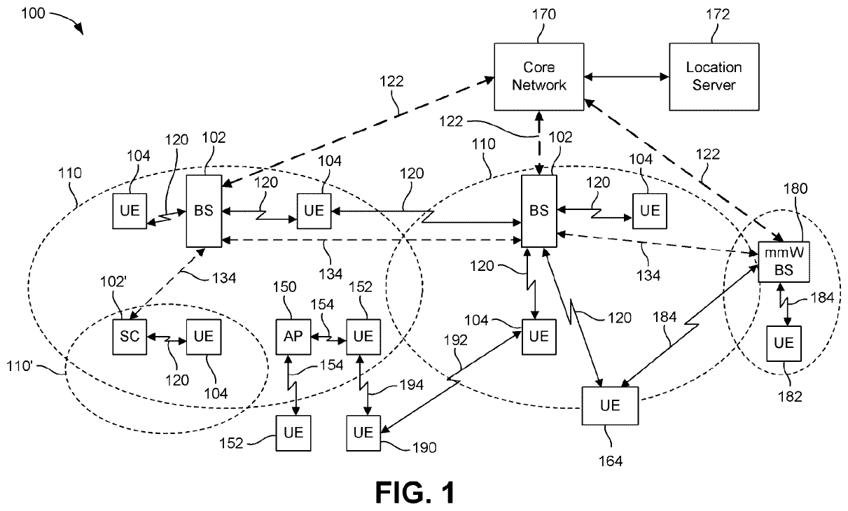

Various aspects of the systems and techniques described herein will be discussed below with respect to the figures. According to various aspects, FIG. 1 illustrates an example of a wireless communications system 100. The wireless communications system 100 (e.g., which may also be referred to as a wireless wide area network (WWAN)) can include various base stations 102 and various UEs 104. In some aspects, the base stations 102 may also be referred to as “network entities” or “network nodes.” One or more of the base stations 102 can be implemented in an aggregated or monolithic base station architecture. Additionally, or alternatively, one or more of the base stations 102 can be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 can include macro cell base stations (e.g., high power cellular base stations) and/or small cell base stations (e.g., low power cellular base stations). In an aspect, the macro cell base station may include eNBs and/or ng-eNBs where the wireless communications system 100 corresponds to a long-term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (e.g., also referred to as reverse link) transmissions from a UE 104 to a base station 102 and/or downlink (e.g., also referred to as forward link) transmissions from a base station 102 to a UE 104. The communication links 120 may use MIMO antenna technology, including spatial multiplexing, beamforming, and/or transmit diversity. The communication links 120 may be provided using one or more carrier frequencies. Allocation of carriers may be asymmetric with respect to downlink and uplink (e.g., a greater or lesser quantity of carriers may be allocated for downlink than for uplink).

Beamforming, which may also be referred to as spatial filtering, directional transmission, or directional reception, is a signal processing technique that may be used at a transmitting device or a receiving device (e.g., one or more of the base stations 102, UEs 104, etc.) to shape or steer an antenna beam (e.g., a transmit beam, a receive beam) along a spatial path between the transmitting device and the receiving device. Beamforming may be implemented based on combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A transmitting device and/or a receiving device (e.g., such as one or more of base stations 102 and/or UEs 104) may use beam sweeping techniques as part of beam forming operations. For example, a base station 102 (e.g., or other transmitting device) may use multiple antennas or antenna arrays (e.g., antenna panels) to conduct beamforming operations for directional communications with a UE 104 (e.g., or other receiving device). Some signals (e.g., synchronization signals, reference signals, beam selection signals, or other control signals) may be transmitted by base station 102 (or other transmitting device) multiple times in different directions. For example, the base station 102 may transmit a signal according to different beamforming weight sets associated with different directions of transmission. Transmissions in different beam directions may be used to identify (e.g., by a transmitting device, such as a base station 102, or by a receiving device, such as a UE 104) a beam direction for later transmission or reception by the base station 102.

Some signals, such as data signals associated with a particular receiving device, may be transmitted by a base station 102 in a single beam direction (e.g., a direction associated with the receiving device, such as a UE 104). In some examples, the beam direction associated with transmissions along a single beam direction may be determined based on a signal that was transmitted in one or more beam directions. For example, a UE 104 may receive one or more of the signals transmitted by the base station 102 in different directions and may report to the base station 104 an indication of the signal that the UE 104 received with a highest signal quality or an otherwise acceptable signal quality.

In some examples, transmissions by a device (e.g., by a base station 102 or a UE 104) may be performed using multiple beam directions, and the device may use a combination of digital precoding or radio frequency beamforming to generate a combined beam for transmission (e.g., from a base station 102 to a UE 104, from a transmitting device to a receiving device, etc.). The UE 104 may report feedback that indicates precoding weights for one or more beam directions, and the feedback may correspond to a configured number of beams across a system bandwidth or one or more sub-bands. The base station 102 may transmit a reference signal (e.g., a cell-specific reference signal (CRS), a channel state information reference signal (CSI-RS), etc.), which may be precoded or unprecoded. The UE 104 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 102, a UE 104 may employ similar techniques for transmitting signals multiple times in different directions (e.g., for identifying a beam direction for subsequent transmission or reception by the UE 104) or for transmitting a signal in a single direction (e.g., for transmitting data to a receiving device).

A receiving device (e.g., a UE 104) may try multiple receive configurations (e.g., directional listening) when receiving various signals from the base station 102, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 can include devices (e.g., UEs, etc.) that communicate with one or more UEs 104, base stations 102, APs 150, etc., utilizing the ultra-wideband (UWB) spectrum. The UWB spectrum can range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHZ and 30 GHZ, also referred to as centimeter wave. Communications using the mmW and/or near mmW radio frequency band have high path loss and a relatively short range. The mmW base station 180 and the UE 182 may utilize beamforming (e.g., transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FR1 (e.g., from 450 to 6,000 Megahertz (MHz)), FR2 (e.g., from 24,250 to 52,600 MHz), FR3 (e.g., above 52,600 MHz), and FR4 (e.g., between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (e.g., whether a PCell or an SCell) corresponds to a carrier frequency and/or component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (e.g., x component carriers) for transmission in each direction. The component carriers may or may not be adjacent to each other on the frequency spectrum. Allocation of carriers may be asymmetric with respect to the downlink and uplink (e.g., a greater or lesser quantity of carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (e.g., 40 MHz), compared to that attained by a single 20 MHz carrier.

In order to operate on multiple carrier frequencies, a base station 102 and/or a UE 104 can be equipped with multiple receivers and/or transmitters. For example, a UE 104 may have two receivers, “Receiver 1” and “Receiver 2,” where “Receiver 1” is a multi-band receiver that can be tuned to band (e.g., carrier frequency) ‘X’ or band ‘Y,’ and “Receiver 2” is a one-band receiver tunable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (e.g., an SCell) in order to measure band ‘Y’ (and vice versa). In contrast, whether the UE 104 is being served in band ‘X’ or band ‘Y,’ because of the separate “Receiver 2,” the UE 104 can measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (e.g., referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (e.g., through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

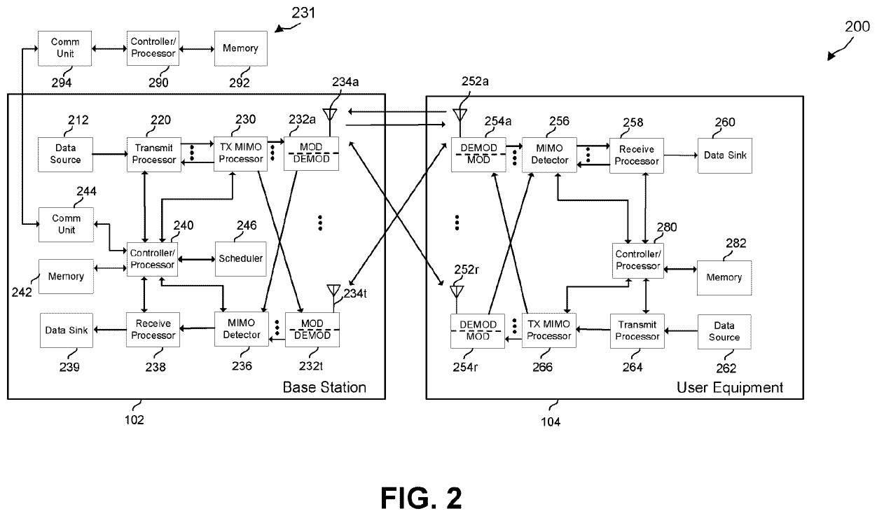

FIG. 2 illustrates a block diagram of an example architecture 200 of a base station 102 and a UE 104 that enables transmission and processing of signals exchanged between the UE and the base station, in accordance with some aspects of the present disclosure. Example architecture 200 includes components of a base station 102 and a UE 104, which may be one of the base stations 102 and one of the UEs 104 illustrated in FIG. 1. Base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based on channel quality indicators (CQIs) received from the UE, process (e.g., encode and modulate) the data for each UE based on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators can be separate components. Each modulator of the modulators 232a to 232t may process a respective output symbol stream (e.g., for an orthogonal frequency-division multiplexing (OFDM) scheme and/or the like) to obtain an output sample stream. Each modulator of the modulators 232a to 232t may further process (e.g., convert to analog, amplify, filter, and upconvert) the output sample stream to obtain a downlink signal. T downlink signals may be transmitted from modulators 232a to 232t via T antennas 234a through 234t, respectively. According to certain aspects described in more detail below, the synchronization signals can be generated with location encoding to convey additional information.

At UE 104, antennas 252a through 252r may receive the downlink signals from base station 102 and/or other base stations and may provide received signals to one or more demodulators (DEMODs) 254a through 254r, respectively. The demodulators 254a through 254r are shown as a combined modulator-demodulator (MOD-DEMOD). In some cases, the modulators and demodulators can be separate components. Each demodulator of the demodulators 254a through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 104, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals (e.g., based on a beta value or a set of beta values associated with the one or more reference signals). The symbols from transmit processor 264 may be precoded by a TX-MIMO processor 266, further processed by modulators 254a through 254r (e.g., for DFT-s-OFDM, CP-OFDM, and/or the like), and transmitted to base station 102. At base station 102, the uplink signals from UE 104 and other UEs may be received by antennas 234a through 234t, processed by demodulators 232a through 232t, detected by a MIMO detector 236 (e.g., if applicable), and further processed by a receive processor 238 to obtain decoded data and control information sent by UE 104. Receive processor 238 may provide the decoded data to a data sink 239 and the decoded control information to controller (e.g., processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with implicit UCI beta value determination for NR.

Memories 242 and 282 may store data and program codes for the base station 102 and the UE 104, respectively. A scheduler 246 may schedule UEs for data transmission on the downlink, uplink, and/or sidelink.

In some aspects, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (e.g., such as a Node B (NB), evolved NB (eNB), NR BS, 5G NB, access point (AP), a transmit receive point (TRP), or a cell, etc.) may be implemented as an aggregated base station (e.g., also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (e.g., such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (e.g., such as the network configuration sponsored by the O-RAN Alliance)), or a virtualized radio access network (e.g., vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

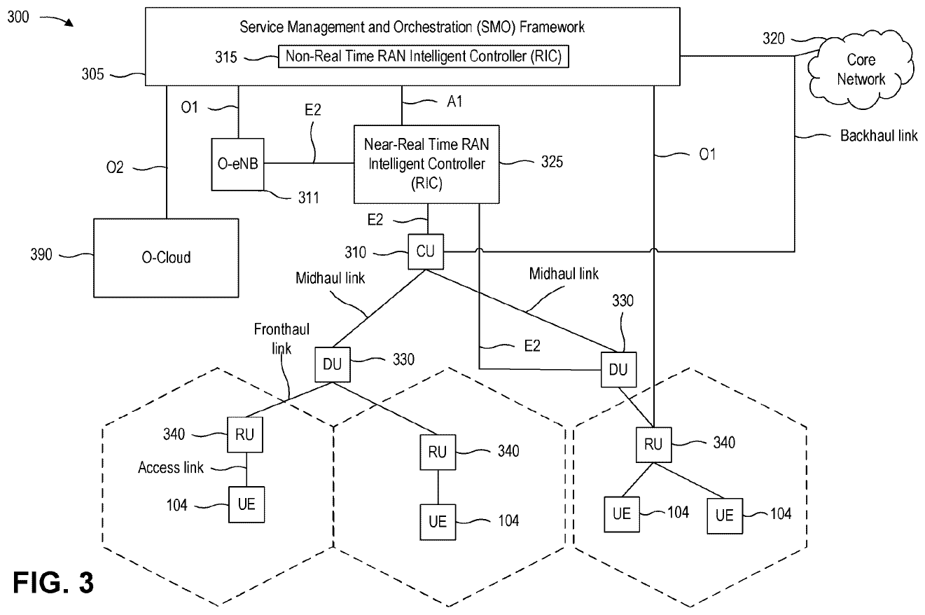

FIG. 3 is a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (e.g., such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 104 via one or more radio frequency (RF) access links. In some implementations, the UE 104 may be simultaneously served by multiple RUs 340.

Each of the units (e.g., the CUS 310, the DUs 330, the RUs 340, as well as the Near-RT RICs 325, the Non-RT RICs 315, and the SMO Framework 305) illustrated in FIG. 3 and/or described herein may include one or more interfaces or be coupled to one or more interfaces configured to receive or transmit signals, data, or information (e.g., collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (e.g., such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (e.g., such as modules for forward error correction (FEC) encoding and decoding, scrambling, modulation and demodulation, or the like) depending on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (e.g., such as performing fast Fourier transform (FFT), inverse FFT (iFFT), digital beamforming, physical random-access channel (PRACH) extraction and filtering, or the like), or both, based on the functional split, such as a lower layer functional split. In such an architecture, the RU(s) 340 can be implemented to handle over the air (OTA) communication with one or more UEs 104. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (e.g., such as an O1 interface). For virtualized network elements, the SMO Framework 305 may be configured to interact with a cloud computing platform (e.g., such as an open cloud (O-Cloud) 390) to perform network element life cycle management (e.g., such as to instantiate virtualized network elements) via a cloud computing platform interface (e.g., such as an O2 interface). Such virtualized network elements can include, but are not limited to, CUs 310, DUs 330, RUs 340, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (e.g., such as via an A1 interface) the Near-RT RIC 325. The Near-RT RIC 325 may be configured to include a logical function that enables near-real-time control and optimization of RAN elements and resources via data collection and actions over an interface (e.g., such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (e.g., such as reconfiguration via O1) or via creation of RAN management policies (e.g., such as A1 policies).

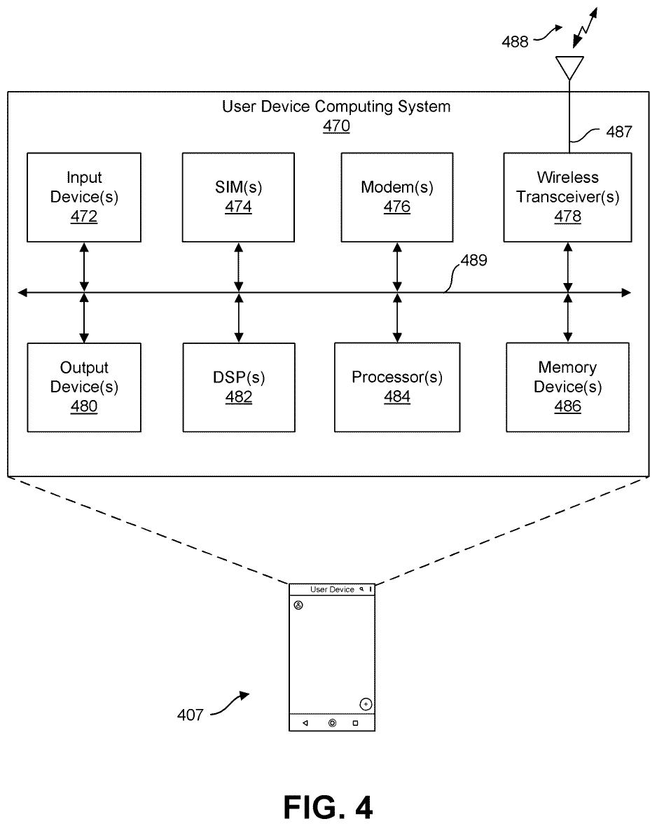

FIG. 4 illustrates an example of a computing system 470 of a wireless device 407. The wireless device 407 may include a client device such as a UE (e.g., UE 104, UE 152, UE 190) or other type of device (e.g., a station (STA) configured to communication using a Wi-Fi interface) that may be used by an end-user. For example, the wireless device 407 may include a mobile phone, router, tablet computer, laptop computer, tracking device, wearable device (e.g., a smart watch, glasses, an extended reality (XR) device such as a virtual reality (VR), augmented reality (AR), or mixed reality (MR) device, etc.), Internet of Things (IoT) device, a vehicle, an aircraft, and/or another device that is configured to communicate over a wireless communications network. The computing system 470 includes software and hardware components that may be electrically or communicatively coupled via a bus 489 (e.g., or may otherwise be in communication, as appropriate). For example, the computing system 470 includes one or more processors 484. The one or more processors 484 may include one or more CPUs, ASICs, FPGAs, APs, GPUs, VPUs, NSPs, microcontrollers, dedicated hardware, any combination thereof, and/or other processing device or system. The bus 489 may be used by the one or more processors 484 to communicate between cores and/or with the one or more memory devices 486.

The computing system 470 may also include one or more memory devices 486, one or more digital signal processors (DSPs) 482, one or more SIMs 474, one or more modems 476, one or more wireless transceivers 478, an antenna 487, one or more input devices 472 (e.g., a camera, a mouse, a keyboard, a touch sensitive screen, a touch pad, a keypad, a microphone, and/or the like), and one or more output devices 480 (e.g., a display, a speaker, a printer, and/or the like).

In some aspects, computing system 470 may include one or more radio frequency (RF) interfaces configured to transmit and/or receive RF signals. In some examples, an RF interface may include components such as modem(s) 476, wireless transceiver(s) 478, and/or antennas 487. The one or more wireless transceivers 478 may transmit and receive wireless signals (e.g., signal 488) via antenna 487 from one or more other devices, such as other wireless devices, network devices (e.g., base stations such as eNBs and/or gNBs, Wi-Fi access points (APs) such as routers, range extenders or the like, etc.), cloud networks, and/or the like. In some examples, the computing system 470 may include multiple antennas or an antenna array that may facilitate simultaneous transmit and receive functionality. Antenna 487 may be an omnidirectional antenna such that radio frequency (RF) signals may be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a Wi-Fi network), a Bluetooth™ network, and/or other network.

In some examples, the wireless signal 488 may be transmitted directly to other wireless devices using sidelink communications (e.g., using a PC5 interface, using a DSRC interface, etc.). Wireless transceivers 478 may be configured to transmit RF signals for performing sidelink communications via antenna 487 in accordance with one or more transmit power parameters that may be associated with one or more regulation modes. Wireless transceivers 478 may also be configured to receive sidelink communication signals having different signal parameters from other wireless devices.

In some examples, the one or more wireless transceivers 478 may include an RF front end including one or more components, such as an amplifier, a mixer (e.g., also referred to as a signal multiplier) for signal down conversion, a frequency synthesizer (e.g., also referred to as an oscillator) that provides signals to the mixer, a baseband filter, an analog-to-digital converter (ADC), one or more power amplifiers, among other components. The RF front-end may generally handle selection and conversion of the wireless signals 488 into a baseband or intermediate frequency and may convert the RF signals to the digital domain.

In some cases, the computing system 470 may include a coding-decoding device (or CODEC) configured to encode and/or decode data transmitted and/or received using the one or more wireless transceivers 478. In some cases, the computing system 470 may include an encryption-decryption device or component configured to encrypt and/or decrypt data (e.g., according to the AES and/or DES standard) transmitted and/or received by the one or more wireless transceivers 478.

The one or more SIMs 474 may each securely store an international mobile subscriber identity (IMSI) number and related key assigned to the user of the wireless device 407. The IMSI and key may be used to identify and authenticate the subscriber when accessing a network provided by a network service provider or operator associated with the one or more SIMs 474. The one or more modems 476 may modulate one or more signals to encode information for transmission using the one or more wireless transceivers 478. The one or more modems 476 may also demodulate signals received by the one or more wireless transceivers 478 in order to decode the transmitted information. In some examples, the one or more modems 476 may include a Wi-Fi modem, a 4G (or LTE) modem, a 5G (or NR) modem, and/or other types of modems. The one or more modems 476 and the one or more wireless transceivers 478 may be used for communicating data for the one or more SIMs 474.

The computing system 470 may also include (and/or be in communication with) one or more non-transitory machine-readable storage media or storage devices (e.g., one or more memory devices 486), which may include, without limitation, local and/or network accessible storage, a disk drive, a drive array, an optical storage device, a solid-state storage device such as a RAM and/or a ROM, which may be programmable, flash-updateable, and/or the like. Such storage devices may be configured to implement any appropriate data storage, including without limitation, various file systems, database structures, and/or the like.

In various aspects, functions may be stored as one or more computer-program products (e.g., instructions or code) in memory device(s) 486 and executed by the one or more processor(s) 484 and/or the one or more DSPs 482. The computing system 470 may also include software elements (e.g., located within the one or more memory devices 486), including, for example, an operating system, device drivers, executable libraries, and/or other code, such as one or more application programs, which may comprise computer programs implementing the functions provided by various aspects, and/or may be designed to implement methods and/or configure systems, as described herein.

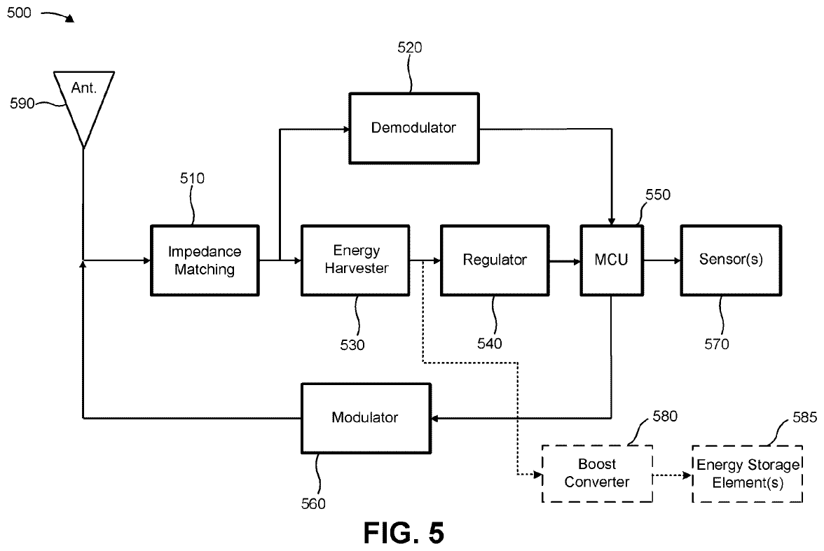

FIG. 5 is a diagram illustrating an example of an architecture of a radio frequency (RF) energy harvesting device 500, in accordance with some examples. As will be described in greater depth below, the RF energy harvesting device 500 can harvest RF energy from one or more RF signals received using an antenna 590. As used herein, the term “energy harvesting” may be used interchangeably with “power harvesting.” In some aspects, energy harvesting device 500 can be implemented as an Internet-of-Things (IoT) device, can be implemented as a sensor, etc., as will be described in greater depth below. In other examples, energy harvesting device 500 can be implemented as a Radio-Frequency Identification (RFID) tag or various other RFID devices.

The energy harvesting device 500 includes one or more antennas 590 that can be used to transmit and receive one or more wireless signals. For example, energy harvesting device 500 can use antenna(s) 590 to receive one or more downlink signals and to transmit one or more uplink signals. An impedance matching component 510 can be used to match the impedance of antenna(s) 590 to the impedance of one or more (or all) of the receive components included in energy harvesting device 500. In some examples, the receive components of energy harvesting device 500 can include a demodulator 520 (e.g., for demodulating a received downlink signal), an energy harvester 530 (e.g., for harvesting RF energy from the received downlink signal), a regulator 540, a micro-controller unit (MCU) 550, a modulator 560 (e.g., for generating an uplink signal). In some cases, the receive components of energy harvesting device 500 may further include one or more sensors 570.

The downlink signals can be received from one or more transmitters. For example, energy harvesting device 500 may receive a downlink signal from a network node or network entity that is included in a same wireless network as the energy harvesting device 500. In some cases, the network entity can be a base station, gNB, etc., that communicates with the energy harvesting device 500 using a cellular communication network. For example, the cellular communication network can be implemented according to the 3G, 4G, 5G, and/or other cellular standard (e.g., including future standards such as 6G and beyond).

In some cases, energy harvesting device 500 can be implemented as a passive or semi-passive energy harvesting device, which perform passive uplink communication by modulating and reflecting a downlink signal received via antenna(s) 590. For example, passive and semi-passive energy harvesting devices may be unable to generate and transmit an uplink signal without first receiving a downlink signal that can be modulated and reflected. In other examples, energy harvesting device 500 may be implemented as an active energy harvesting device, which utilizes a powered transceiver to perform active uplink communication. An active energy harvesting device is able to generate and transmit an uplink signal without first receiving a downlink signal (e.g., by using an on-device power source to energize its powered transceiver).

An active or semi-passive energy harvesting device may include one or more energy storage elements 585 (e.g., collectively referred to as an “energy reservoir”). For example, the one or more energy storage elements 585 can include batteries, capacitors, etc. In some examples, the one or more energy storage elements 585 may be associated with a boost converter 580. The boost converter 580 can receive as input at least a portion of the energy harvested by energy harvester 530 (e.g., with a remaining portion of the harvested energy being provided as instantaneous power for operating the energy harvesting device 500). In some aspects, the boost converter 580 may be a step-up converter that steps up voltage from its input to its output (e.g., and steps down current from its input to its output). In some examples, boost converter 580 can be used to step up the harvested energy generated by energy harvester 530 to a voltage level associated with charging the one or more energy storage elements 585. An active or semi-passive energy harvesting device may include one or more energy storage elements 585 and may include one or more boost converters 580. A quantity of energy storage elements 585 may be the same as or different than a quantity of boost converters 580 included in an active or semi-passive energy harvesting device.

A passive energy harvesting device does not include an energy storage element 585 or other on-device power source. For example, a passive energy harvesting device may be powered using only RF energy harvested from a downlink signal (e.g., using energy harvester 530). As mentioned previously, a semi-passive energy harvesting device can include one or more energy storage elements 585 and/or other on-device power sources. The energy storage element 585 of a semi-passive energy harvesting device can be used to augment or supplement the RF energy harvested from a downlink signal. In some cases, the energy storage element 585 of a semi-passive energy harvesting device may store insufficient energy to transmit an uplink communication without first receiving a downlink communication (e.g., minimum transmit power of the semi-passive device >capacity of the energy storage element). An active energy harvesting device can include one or more energy storage elements 585 and/or other on-device power sources that can power uplink communication without using supplemental harvested RF energy (e.g., minimum transmit power of the active device <capacity of the energy storage element). The energy storage element(s) 585 included in an active energy harvesting device and/or a semi-passive energy harvesting device can be charged using harvested RF energy.

As mentioned above, passive and semi-passive energy harvesting devices transmit uplink communications by performing backscatter modulation to modulate and reflect a received downlink signal. The received downlink signal is used to provide both electrical power (e.g., to perform demodulation, local processing, and modulation) and a carrier wave for uplink communication (e.g., the reflection of the downlink signal). For example, a portion of the downlink signal will be backscattered as an uplink signal and a remaining portion of the downlinks signal can be used to perform energy harvesting.

Active energy harvesting devices can transmit uplink communications without performing backscatter modulation and without receiving a corresponding downlink signal (e.g., an active energy harvesting device includes an energy storage element to provide electrical power and includes a powered transceiver to generate a carrier wave for an uplink communication). In the absence of a downlink signal, passive and semi-passive energy harvesting devices cannot transmit an uplink signal (e.g., passive communication). Active energy harvesting devices do not depend on receiving a downlink signal in order to transmit an uplink signal and can transmit an uplink signal as desired (e.g., active communication).

In examples in which the energy harvesting device 500 is implemented as a passive or semi-passive energy harvesting device, a continuous carrier wave downlink signal may be received using antenna(s) 590 and modulated (e.g., re-modulated) for uplink communication. In some cases, a modulator 560 can be used to modulate the reflected (e.g., backscattered) portion of the downlink signal. For example, the continuous carrier wave may be a continuous sinusoidal wave (e.g., sine or cosine waveform) and modulator 560 can perform modulation based on varying one or more of the amplitude and the phase of the backscattered reflection. Based on modulating the backscattered reflection, modulator 560 can encode digital symbols (e.g., such as binary symbols or more complex systems of symbols) indicative of an uplink communication or data message. For example, the uplink communication may be indicative of sensor data or other information associated with the one or more sensors 570 included in energy harvesting device 500.

As mentioned previously, impedance matching component 510 can be used to match the impedance of antenna(s) 590 to the receive components of energy harvesting device 500 when receiving the downlink signal (e.g., when receiving the continuous carrier wave). In some examples, during backscatter operation (e.g., when transmitting an uplink signal), modulation can be performed based on intentionally mismatching the antenna input impedance to cause a portion of the incident downlink signal to be scattered back. The phase and amplitude of the backscattered reflection may be determined based on the impedance loading on the antenna(s) 590. Based on varying the antenna impedance (e.g., varying the impedance mismatch between antenna(s) 590 and the remaining components of energy harvesting device 500), digital symbols and/or binary information can be encoded (e.g., modulated) onto the backscattered reflection. Varying the antenna impedance to modulate the phase and/or amplitude of the backscattered reflection can be performed using modulator 560.

As illustrated in FIG. 5, a portion of a downlink signal received using antenna(s) 590 can be provided to a demodulator 520, which performs demodulation and provides a downlink communication (e.g., carried or modulated on the downlink signal) to a micro-controller unit (MCU) 550 or other processor included in the energy harvesting device 500. A remaining portion of the downlink signal received using antenna(s) 590 can be provided to energy harvester 530, which harvests RF energy from the downlink signal. For example, energy harvester 530 can harvest RF energy based on performing AC-to-DC (alternating current-to-direct current) conversion, wherein an AC current is generated from the sinusoidal carrier wave of the downlink signal and the converted DC current is used to power the energy harvesting device 500. In some aspects, energy harvester 530 can include one or more rectifiers for performing AC-to-DC conversion. A rectifier can include one or more diodes or thin-film transistors (TFTs). In one illustrative example, energy harvester 530 can include one or more Schottky diode-based rectifiers. In some cases, energy harvester 530 can include one or more TFT-based rectifiers.

The output of the energy harvester 530 is a DC current generated from (e.g., harvested from) the portion of the downlink signal provided to the energy harvester 530. In some aspects, the DC current output of energy harvester 530 may vary with the input provided to the energy harvester 530. For example, an increase in the input current to energy harvester 530 can be associated with an increase in the output DC current generated by energy harvester 530. In some cases, MCU 550 may be associated with a narrow band of acceptable DC current values. Regulator 540 can be used to remove or otherwise decrease variation(s) in the DC current generated as output by energy harvester 530. For example, regulator 540 can remove or smooth spikes (e.g., increases) in the DC current output by energy harvester 530 (e.g., such that the DC current provided as input to MCU 550 by regulator 540 remains below a first threshold). In some cases, regulator 540 can remove or otherwise compensate for drops or decreases in the DC current output by energy harvester 530 (e.g., such that the DC current provided as input to MCU 550 by regulator 540 remains above a second threshold).

In some aspects, the harvested DC current (e.g., generated by energy harvester 530 and regulated upward or downward as needed by regulator 530) can be used to power MCU 550 and one or more additional components included in the energy harvesting device 500. For example, the harvested DC current can additionally be used to power one or more (or all) of the impedance matching 510, demodulator 520, regulator 540, MCU 550, sensors 570, modulator 560, etc. For example, sensors 570 and modulator 560 can receive at least a portion of the harvested DC current that remains after MCU 550 (e.g., that is not consumed by MCU 550). In some cases, the harvested DC current output by regulator 540 can be provided to MCU 550, modulator 560, and sensors 570 in series, in parallel, or a combination thereof.

In some examples, sensors 570 can be used to obtain sensor data (e.g., such as sensor data associated with an environment in which the energy harvesting device 500 is located). Sensors 570 can include one or more sensors, which may be of a same or different type(s). In some aspects, one or more (or all) of the sensors 570 can be configured to obtain sensor data based on control information included in a downlink signal received using antenna(s) 590. For example, one or more of the sensors 570 can be configured based on a downlink communication obtained based on demodulating a received downlink signal using demodulator 520. In one illustrative example, sensor data can be transmitted based on using modulator 560 to modulate (e.g., vary one or more of amplitude and/or phase of) a backscatter reflection of the continuous carrier wave received at antenna(s) 590. Based on modulating the backscattered reflection, modulator 560 can encode digital symbols (e.g., such as binary symbols or more complex systems of symbols) indicative of an uplink communication or data message. In some examples, modulator 560 can generate an uplink, backscatter modulated signal based on receiving sensor data directly from sensors 570. In some examples, modulator 560 can generate an uplink, backscatter modulated signal based on received sensor data from MCU 550 (e.g., based on MCU 550 receiving sensor data directly from sensors 570).

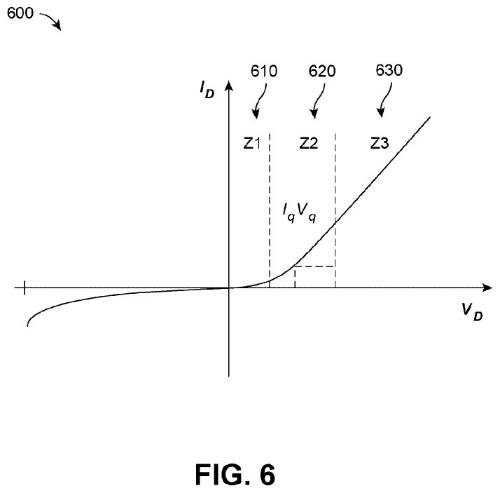

FIG. 6 is a diagram 600 illustrating an example of a small signal rectification operation that may be associated with performing energy harvesting, in accordance with some examples. In one illustrative example, the small signal rectification operation may be a small signal rectification operation associated with a Schottky diode barrier (e.g., a Schottky diode used to perform rectification associated with energy harvester 530 illustrated in FIG. 5).

In some cases, the rectification process in a diode barrier (e.g., Schottky diode or other diode) associated with performing energy harvesting can be classified into small signal operation and large signal operation. For example, large signal operation is associated with rectifying an input signal (e.g., a received downlink signal at an energy harvesting device that includes the diode) having a relatively large amplitude signal that causes the diode to operate in its resistive zone. Small signal operation (e.g., such as the example small signal operation illustrated in FIG. 6) can be associated with rectifying an input signal (e.g., or portion thereof) having a relatively small amplitude signal, such that the diode does not operate in its resistive zone.

For example, small signal operation of a rectifying process in a Schottky diode barrier may be associated with three different operating zones, as depicted in FIG. 6. In a first operating zone 610, the diode behavior may be approximated as quadratic. For example, in the first operating zone 610, the output signal of the diode may be proportional to the square of the input signal to the diode. In some cases, the first operating zone 610 may also be referred to as a square law zone. In a second operating zone 620, the diode behavior may become more affected by other contributions, and the relationship between the output-input signal of the diode may decrease from quadratic towards linear. In some cases, the second operating zone 620 may also be referred to as a transition zone. In a third operating zone 630, the output signal of the diode may be proportional to the input signal to the diode (e.g., a linear relationship between input and output signals of the diode) and no DC component is generated. The third operating zone 630 may also be referred to as a resistive zone.

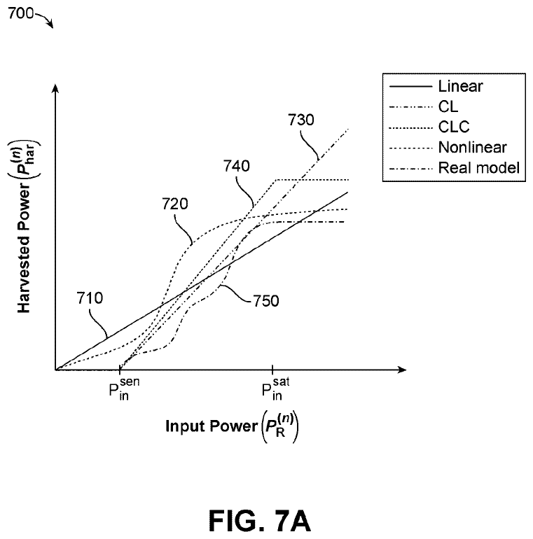

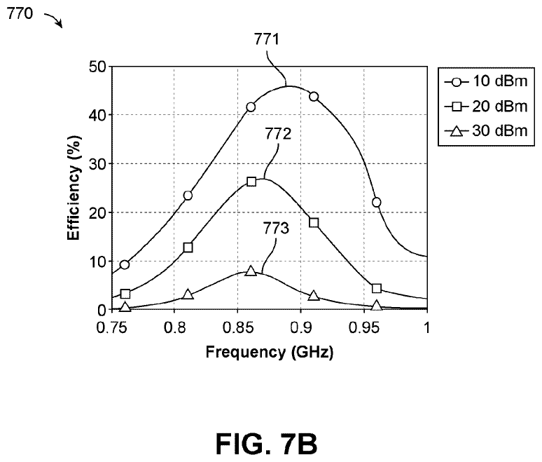

FIG. 7A is a diagram 700 illustrating examples of input power-harvested power conversion models that may be associated with various energy harvesting devices (e.g., such as the energy harvesting device 500 illustrated in the example of FIG. 5, above). Diagram 700 includes a first power conversion model 710, a second power conversion model 720, a third power conversion model 730, a fourth power conversion model 740, and a fifth power conversion model 750. In some aspects, different energy harvesting devices may be associated with different models between input power (e.g., the total RF energy or power of the portion of the received downlink signal provided to energy harvester 530 illustrated in FIG. 5) and harvested power (e.g., the RF energy or power that is harvested and output by energy harvester 530). In some aspects, the power conversion models 710-750 may be associated with passive, semi-passive, and/or active energy harvesting devices.

The first power conversion model 710 can be associated with a first type or category of energy harvesting devices. For example, energy harvesting devices having the first power conversion model 710 can provide harvested power as a continuous, linear, increasing function of the input RF power.

The second power conversion model 720 can be associated with a second type or category of energy harvesting devices. For example, energy harvesting devices having the second power conversion model 720 can provide harvested power as a continuous, non-linear, increasing function of the input RF power.

The third power conversion model 730 can be associated with a third type or category of energy harvesting device. For example, energy harvesting devices having the third power conversion model 730 can provide harvested power that is a continuous, linear, increasing function of the input RF power, given that the input RF power is above a sensitivity threshold

$$( {P}_{i n}^{s e n} ) .$$

The sensitivity threshold

$${P}_{i n}^{s e n}$$

call represent a minimum input RF power for which the energy harvesting device is able to perform harvesting (e.g., is able to harvest a non-zero amount of power). When the input RF power is below the sensitivity threshold

$$( {P}_{i n}^{s e n} ) ,$$

the harvested power is zero.

The fourth power conversion model 740 can be associated with a fourth type or category of energy harvesting device. For example, energy harvesting devices having the fourth power conversion model 740 can provide harvested power that is a continuous, linear, increasing function of the input RF power, given that the input RF power is both above the sensitivity threshold

$${P}_{i n}^{s e n}$$

and is below a saturation threshold

$${P}_{i n}^{sat} .$$

As illustrated, the saturation threshold

$${P}_{i n}^{sat}$$

is greater than the sensitivity threshold

$${P}_{i n}^{s e n} .$$

When the input RF power is below the sensitivity threshold

$${P}_{i n}^{s e n} ,$$

the harvested power is zero. When the input RF power is above the saturation threshold

$${P}_{i n}^{sat} ,$$

the harvested power output saturates (e.g., remains approximately constant for any input RF power above the saturation threshold).

The fifth power conversion model 750 can be associated with a fifth type or category of energy harvesting device. For example, for an input RF power between the sensitivity threshold

$${P}_{i n}^{s e n}$$

and the saturation threshold

$${P}_{i n}^{sat} ,$$

energy harvesting devices having the fifth power conversion model 750 can provide harvested power that is a continuous, non-linear, increasing function of the input RF power.

In some examples, an efficiency of an energy harvesting device can be determined as a percentage of the input RF power that is converted into harvested power. FIG. 7B is a diagram 770 illustrating an example of energy conversion efficiency vs. frequency (e.g., of an input waveform to the energy harvesting device) for different input powers. For example, a first efficiency-frequency relationship 771 is shown for an input RF power of −10 dBm (decibel milliwatts), a second efficiency-frequency relationship 772 is shown for an input RF power of −20 dBm, and a third efficiency-frequency relationship 773 is shown for an input RF power of −30 dBm.

The three efficiency-frequency relationships 771, 772, 773 depicted in FIG. 7B may each be associated with an optimum operating frequency, or an optimum operating frequency band, for which the energy conversion efficiency of a corresponding energy harvesting device is maximized. For example, for an input RF power of −30 dBm, an energy harvesting device with the third energy conversion model 773 may maximize its energy conversion efficiency with an input RF waveform centered at a frequency of 0.86 GHz. In another example, for an input RF power of −20 dBm, an energy harvesting device with the second energy conversion model 772 may maximize its energy conversion efficiency with an input RF waveform centered at a frequency of 0.87 GHz. In another example, for an input RF power of −10 dBm, an energy harvesting device with the first energy conversion model 771 may maximize its energy conversion efficiency with an input RF waveform centered at a frequency of 0.89 GHz.

In some aspects, the efficiency of an energy harvesting device may vary based on the input RF power (e.g., the RF power of the downlink signal received at an antenna of the energy harvesting device) and the center frequency of the input RF waveform. For example, as illustrated in FIG. 7B, the maximum or peak efficiency of an energy harvesting device that receives a relatively low input RF power may be less than the maximum or peak efficiency of an energy harvesting device that receives a relatively high input RF power (e.g., at −30 dBm the peak efficiency of energy conversion model 773 is below 10%, at −20 dBm the peak efficiency of energy conversion model 772 is approximately 25%, and at −10 dBm the peak efficiency of energy conversion model 771 is approximately 45%). In some cases, conversion efficiency can decrease for frequencies that are greater than the optimum input center frequency and can decrease for frequencies that are less than the optimum input center frequency.

In some aspects, the conversion efficiency of an energy harvesting device may be associated with one or more energy conversion characteristics (e.g., also referred to as energy harvesting characteristics). For example, one or more characteristics may be indicative of a relationship between the conversion efficiency of an energy harvesting device and input frequency. In one illustrative example, an energy harvesting device may have an approximately constant conversion efficiency over a narrowband operating bandwidth (e.g., such as 20 MHz or less). In such examples, the energy harvesting device can receive RF energy from a multi-sine downlink wave with uniform power distribution. In another illustrative example, an energy harvesting device with a wideband operating bandwidth (e.g., such as 20 MHz or greater) may have a conversion efficiency that is a non-linear function of input frequency over the wideband. In such examples, the energy harvesting device may receive RF energy based on Gaussian and/or raised-cosine filters being used in combination with (e.g., on top of) the multi-sine downlink wave described above for narrowband operating bandwidths.

In some aspects, the energy conversion efficiency of an energy harvesting device may vary continuously with the input RF power. For example, the energy conversion efficiency may be zero for input powers less than the sensitivity threshold

$$( {P}_{i n}^{s e n} )$$

(e.g., based on the harvested power being equal to zero when the input RF power is below the sensitivity threshold, and conversion efficiency=harvested power/input RF power). In some examples, the energy conversion efficiency of an energy harvesting device may vary over different input frequencies (e.g., as described above with respect to FIG. 7B) and may additionally vary over different input RF powers. For example, in some cases the energy conversion efficiency of an energy harvesting device may be approximately linear with input RF power, for input RF power values between the sensitivity threshold

$$( {P}_{i n}^{s e n} )$$

and a first input RF power value greater than

$${P}_{i n}^{s e n} .$$

The energy conversion efficiency may increase linearly with the input RF power from and above

$${P}_{i n}^{s e n} .$$

At input RF powers beyond the linear conversion efficiency zone, the energy conversion efficiency of the energy harvesting device may increase and/or decrease non-linearly with further increases in input RF power. In some examples, the energy conversion efficiency may include one or more additional zones of linear increase (e.g., and/or linear decrease) with input RF power, in addition to an initial linear conversion efficiency zone beginning at the sensitivity threshold

$${P}_{i n}^{s e n} .$$

In some cases, existing approaches to wireless energy harvesting (e.g., such as energy harvesting associated with RFID tags and/or RFID devices) are associated with short-range implementations. For example, RFID devices (and/or passive IoT devices implementing RFID-based communications and energy harvesting) may support wireless energy harvesting and backscatter modulation over distances of 10 meters or less. For transmitters and energy harvesting devices that are separated by greater than 10 meters, wireless energy harvesting and backscatter modulation may be difficult to implement based on insufficient link budget issues.

There is a need for systems and techniques that can be used to provide improved wireless energy harvesting and/or backscatter modulation-based communications between an energy harvesting device (e.g., passive, semi-passive, or active IoT device, etc.) and a network node or transmitter (e.g., gNB or base station). There is also a need for systems and techniques that can be used to provide wireless energy harvesting and backscatter modulation-based communications over a greater range than existing RFID-based approaches. For example, passive or semi-passive IoT devices may include one or more sensors and can be utilized to perform tasks such as asset management, logistics tracking, warehousing, manufacturing, etc. In such examples, the passive (or semi-passive) IoT device(s) may often be located at distances greater than 10 meters away from a corresponding base station or transmitter.

As will be discussed in greater depth below, the systems and techniques described herein can be used to provide optimized or improved wireless energy transfer for an energy harvesting device, based on Energy State Indication (ESI) information and/or an ESI report provided from the energy harvesting device to a corresponding network device (e.g., base station, gNB, energy transmitter, etc.). In some cases, based on receiving the ESI information and/or ESI report from an energy harvesting device, an energy transmitter (e.g., gNB, base station, or other network device, etc.) can generate a downlink RF signal that is optimized for energy harvesting by the energy harvesting device. For example, the network device can schedule energy transmission to an energy harvesting device based on previously received ESI information associated with the energy harvesting device. In some examples, the network device can schedule energy transmission to the energy harvesting device wherein the scheduled energy transmission utilizes a waveform and/or power that is determined based on the ESI information associated with the energy harvesting device.

In some existing approaches, the downlink from the network device to the energy harvesting device (e.g., also referred to as a “power link”) may be the bottleneck link in the link budget between the network device and the energy harvesting device. For example, energy harvesting circuits (e.g., such as energy harvester 530 illustrated in FIG. 5) may need a relatively high input power to perform energy harvesting. In some aspects, the input power to an energy harvesting circuit may have a floor (e.g., sensitivity threshold) of −20 dBm or more. In some examples, an energy harvesting circuit may need a relatively high input power based on a sensitivity threshold associated with the energy harvesting device. In some cases, an input power of −20 dBm or less may be associated with a conversion efficiency (e.g., at the energy harvester) of less than 1%. Multi-path reflections can cause fading to the downlink energy signal prior to being received by the energy harvesting device, which may reduce the range of the energy signal transmitted by the network device, may reduce the range of the backscatter modulated uplink signal transmitted by the energy harvesting device, or both.

In one illustrative example, ESI information indicative of a current energy harvesting status of an energy harvesting device can be transmitted to a network device (e.g., base station, gNB, reader, etc.) associated with the energy harvesting device. For example, the ESI information can be transmitted using one or more ESI reports indicative of the current energy harvesting status and/or energy conversion efficiency of an energy harvesting device. In some aspects, an ESI report can additionally, or alternatively, include ESI information indicative of an energy state and/or an energy headroom currently associated with an energy harvesting device. In some cases, based on receiving the ESI information and/or ESI report from an energy harvesting device, a network device (e.g., also referred to as a “reader” or an “energy transmitter”) can generate a downlink RF signal that is optimized for energy harvesting by the energy harvesting device. For example, the network device can schedule energy transmission to an energy harvesting device based on previously received ESI information associated with the energy harvesting device. In some examples, the network device can schedule energy transmission to the energy harvesting device wherein the scheduled energy transmission utilizes a waveform and/or power that is determined based on the ESI information associated with the energy harvesting device.

For example, for a given downlink signal with a given input RF power received at an energy harvesting device, a first portion of the input RF power may be provided to the device's energy harvester (e.g., with a percentage being converted to useful electrical power based on the conversion efficiency of the harvester, and the remaining percentage wasted or dissipated as heat, etc.). A remaining, second portion of the input RF power is available for use in the backscattered uplink transmission (e.g., the second portion of the input power is reflected and modulated with the uplink communication). By optimizing or improving the conversion efficiency at the energy harvesting device, the energy harvesting device may obtain the same amount of useful electrical power from a smaller portion of the given input RF power (e.g., 25% conversion efficiency applied to 50% of the input RF power is equal to 50% conversion efficiency applied to 25% of the input RF power). In one illustrative example, a base station or other transmitter can receive ESI information and/or an ESI report from an energy harvesting device, wherein the report is indicative of a current energy harvesting status of the energy harvesting device. Based on the ESI report, the base station can transmit a downlink RF signal (e.g., also referred to as a “power signal” or “energy signal”) that is optimized based on the energy harvesting status of the energy harvesting device associated with the ESI report. In some aspects, based on the energy harvesting device more efficiently harvesting (e.g., converting) the downlink RF power into harvested power, an increased amount of the downlink RF power remains available for use in the backscattered uplink transmission by the energy harvesting device.

In one illustrative example, ESI information (e.g., included in an ESI report transmitted from an energy harvesting device to a corresponding network device) can be indicative of a current energy harvesting status of an energy harvesting device. In some aspects, some (or all) of the ESI information included in an ESI report may be associated with an ESI latency bound. The ESI latency bound may be determined or otherwise configured by the network device (e.g., base station, gNB, etc.) associated with a given energy harvesting device. For example, the ESI latency bound can be indicated to the energy harvesting device via an ESI configuration information transmitted from the network device to the energy harvesting device.

The ESI latency bound may be indicative of a time window (e.g., time period) in which the measurements used to generate ESI information and/or an ESI report are to be obtained by the energy harvesting device. For example, a network device may configure an energy harvesting device with an ESI latency bound of 100 milliseconds (ms). In such an example, when the energy harvesting device is triggered to generate and transmit an ESI report, the ESI information included in the ESI report is be based on reported values and/or past measurements that are less than 100 ms old (e.g., past measurements utilized in generating the ESI report are collected within the ESI latency window, relative to the time at which the ESI report is triggered or transmitted). If a reported value or past measurement for inclusion in the ESI report is older than the ESI latency bound, then the energy harvesting device may perform a new measurement to obtain values within the ESI latency bound.

In some aspects, one or more (or all) of the reported values and/or measurements included in the ESI information (and/or ESI report) can be associated with an ESI measurement window. The ESI measurement window can represent a period of time associated with each reported value or measurement of the ESI information. For example, the ESI measurement window can be a time resolution of measurement used by an energy harvesting device to determine the ESI information and/or generate an ESI report. The ESI measurement window may be shorter than the ESI latency bound described above. In one example, the ESI latency bound may be 100 ms and the ESI measurement window may be 10 ms, indicating that each measured value included in the ESI information should be less than 100 ms old (e.g., based on the ESI latency bound) and that each measured value should be determined over a 10 ms measurement window.

In one illustrative example, ESI information can be indicative of a current energy harvesting status of a given energy harvesting device. For example, the ESI information may be indicative of the conversion efficiency associated with a rectifier (and/or energy harvester) included in the given energy harvesting device. For example, the conversion efficiency ESI information can include a conversion efficiency percentage (e.g., harvested RF power/input RF power), separate harvested RF power and input RF power values, or both. In some examples, when the ESI information includes rectifier conversion efficiency, the rectifier conversion efficiency may be measured or otherwise determined over the ESI measurement window or the ESI latency bound. In some aspects, the ESI information may be indicative of an instantaneous or most recently determined rectifier conversion efficiency measurement or value, within the ESI latency bound. In some cases, the ESI information may be indicative of an instantaneous or most recently determined rectifier conversion efficiency measurement or value within the ESI latency bound, wherein the rectifier conversion efficiency is averaged over a pre-determined or minimum time period (e.g., which may be the same as the ESI measurement window).

In another illustrative example, the ESI information can be indicative of one or more outputs of the rectifier or energy harvester included in a given energy harvesting device. For example, the ESI information may be indicative of an output power of the rectifier. In some cases, the ESI information may additionally, or alternatively, be indicative of an output current and/or an output voltage of the rectifier. In some examples, the rectifier output information may be measured or otherwise determined over the ESI measurement window or the ESI latency bound. In some aspects, the ESI information may be indicative of an instantaneous or most recently determined rectifier output value, within the time period given by the ESI latency bound. In some cases, the ESI information may be indicative of an instantaneous or most recently determined rectifier output within the ESI latency bound, wherein the measured rectifier output value is averaged over a pre-determined or minimum time period (e.g., which may be the same as the ESI measurement window).

In another illustrative example, the ESI information can be indicative of one or more inputs provided to the rectifier or energy harvester included in a given energy harvesting device. For example, the ESI information may be indicative of an input power of the rectifier (e.g., the input RF power provided to the rectifier by the energy harvesting device, based on a downlink energy signal received at an antenna of the energy harvesting device). In some cases, the ESI information may additionally, or alternatively, be indicative of an input current and/or an input voltage of the rectifier. In some examples, the rectifier input information may be measured or otherwise determined over the ESI measurement window or the ESI latency bound. In some aspects, the ESI information may be indicative of an instantaneous or most recently determined rectifier input value, within the time period given by the ESI latency bound. In some cases, the ESI information may be indicative of an instantaneous or most recently determined rectifier input within the ESI latency bound, wherein the measured rectifier input value is averaged over a pre-determined or minimum time period (e.g., which may be the same as the ESI measurement window).

In another illustrative example, the ESI information may be indicative of a current operating zone of the rectifier or energy harvested included in a given energy harvesting device. For example, the ESI information may indicate whether the rectifier is currently operating in a linear, non-linear, or saturation regime (e.g., within the ESI latency bound and/or a specific ESI measurement window within the ESI latency bound). For example, the ESI information may indicate that the rectifier of the energy harvesting device is currently operating in one of the three zones 610, 620, 630 illustrated in FIG. 6. In some cases, the ESI information may indicate that the rectifier of the energy harvesting device is currently operating below the sensitivity threshold

$${P}_{i n}^{s e n}$$

illustrated in FIG. 7A, above the sensitivity threshold

$${P}_{i n}^{s e n}$$

and below the saturation threshold

$${P}_{i n}^{sat}$$

illustrated in FIG. 7A, above the saturation

$${P}_{i n}^{sat}$$

illustrated in FIG. 7A, etc.

In some cases, the ESI information can be indicative of an instantaneous measurement value and/or a most recently measured value within the ESI latency bound, as described above. In some cases, an instantaneous or most recent measurement value included in the ESI information may be averaged over a pre-determined or minimum time period. The pre-determined or minimum time period may be the same as or different than the ESI measurement window.

In some cases, the ESI information can be indicative of measurement values associated with the ESI measurement window, wherein the ESI measurement window is shorter than the ESI latency bound. In some aspects, the ESI measurement window can be pre-configured at the energy harvesting device. For example, a corresponding network device associated with the energy harvesting device can pre-configure the ESI measurement window using one or more ESI configuration messages. In one illustrative example, the network device can use one or more Radio Resource Control (RRC) messages to pre-configure the ESI measurement window for a given energy harvesting device (e.g., one or more RRC messages can be used to communicate at least a portion of the ESI configuration information determined by the network device). In some examples, the ESI measurement window (and/or ESI latency bound) can be dynamically indicated by the network device to the energy harvesting device.

For ESI information associated with or measured for an ESI measurement window, in some cases the ESI information can include an averaged value over the ESI measurement window. For example, if an energy harvesting device obtains 10 discrete measurements of rectifier conversion efficiency, input power, output power, etc., within a given ESI measurement window, the energy harvesting device can include an average of the 10 discrete measurements as the corresponding ESI information included in the ESI report to the network device. In some cases, the ESI information can include the maximum measured value and/or the minimum measured value for a given ESI parameter within the ESI measurement window. In some examples, the ESI information can include an average of a pre-determined quantity of maximum measured values within the ESI measurement window (e.g., average of top three, top four, top five, etc.). The ESI information may additionally, or alternatively, include an average of a pre-determined quantity of minimum measured values within the ESI measurement window (e.g., average of bottom three, bottom four, bottom five, etc.). In examples in which the ESI information includes averages of maximum and minimum values within the ESI measurement window, the same quantity of measured values may be used to determine the average maximum and the average minimum, or different quantities of measured values may be sued for determining the average maximum and average minimum.

In some aspects, the ESI information may additionally, or alternatively, be indicative of an energy status of a given energy harvesting device. For example, the ESI information can indicate a current stored energy associated with the energy harvesting device (e.g., a current stored energy of energy storage element 585, illustrated in the energy harvesting device 500 of FIG. 5). In some cases, the ESI information can additionally, or alternatively, indicate an energy headroom associated with the energy harvesting device (e.g., the difference between current stored energy and maximum required energy).

The ESI information can indicate the energy status of a given energy harvesting device based on including one or more indications of the currently stored energy associated with the energy harvesting device. For example, the ESI information can indicate the currently stored energy associated with energy storage element(s) 585 illustrated in the energy harvesting device 500 of FIG. 5. In some aspects, the ESI information can indicate a state of charge of energy storage element 585. For example, the ESI information may indicate the currently stored energy as a percentage of the total storage capacity of the energy storage element included in the energy harvesting device. In some cases, the ESI information can indicate the currently stored energy as a quantity or value (e.g., in Joules (J), milli-Joules (mJ), etc.).

In some cases, a network device (e.g., base station, gNB, etc.) associated with the energy harvesting device can indicate or configure one or more energy thresholds for reporting some (or all) of the ESI information. For example, the network device may indicate (e.g., via ESI configuration information or messages) one or more energy thresholds for reporting ESI information. In one illustrative example, the energy harvesting device can skip ESI reporting based on the currently stored energy of the energy harvesting device being greater than or equal to the energy threshold configured by the network device. If the currently stored energy of the energy harvesting device is less than the energy threshold configured by the network device, the energy harvesting device may perform ESI reporting and transmit ESI information to the network device.

In some aspects, an ESI reporting frequency may be based on a stored energy level associated with a given energy harvesting device. For example, relatively infrequent ESI reporting may be performed by an energy harvesting device with a high stored energy state (e.g., high stored energy level). Relatively infrequent ESI reporting may additionally, or alternatively, be performed by an energy harvesting device with a low stored energy state (e.g., low stored energy level). In some examples, relatively frequent ESI reporting may be performed by an energy harvesting device with a moderate to low stored energy state (e.g., moderate to low stored energy level). In some aspects, the stored energy level thresholds associated with ESI reporting frequency may be the same as the energy threshold(s) described above with respect to the energy device determining whether an ESI report may be skipped. In some examples, the stored energy level thresholds associated with ESI reporting frequency may be different than the energy threshold(s) described above with respect to skipping ESI reporting.

In another illustrative example, ESI information can indicate the energy headroom currently associated with a given energy harvesting device. The energy headroom can correspond to the difference between the currently stored energy level of the energy harvesting device and the maximum required energy level of the energy harvesting device. For example, in some cases the ESI information can indicate an energy headroom P_{EH} as:

$${P}_{E H} = {P}_{c u r r e n t} - \{ {P}_{D L} + 10 {log}_{10} {\sum }_{i = 0}^{{M}_{D L}} {T}_{D , i} + {P}_{s t a t i c} \} - \{ {P}_{U L} + 10 {log}_{10} {\sum }_{i = 0}^{{M}_{U L}} {T}_{U , i} + α {P}_{P L} \} \qquad Eq . ( 1 )$$

Here, P_{EH} represents the energy headroom of a given energy harvesting device. P_{current} is indicative of the currently stored energy associated with the energy harvesting device (e.g., the currently stored energy associated with energy storage element 585 illustrated in the energy harvesting device 500 of FIG. 5). P_{DL} represents an instantaneous energy consumption associated with a downlink (DL) transmission received by the energy harvesting device and P_{UL} represents an instantaneous energy consumption associated with an uplink (UL) transmission by the energy harvesting device. M_{DL} represents a total quantity of downlink transmissions over a given time window and M_{UL} represents a total quantity of uplink transmissions over the same given time window. For example, the time window associated with M_{DL} and M_{UL} can be the same as the time window for which the energy headroom P_{EH} is determined (e.g., the ESI measurement window or other measurement window indicated to the energy harvesting device via an ESI configuration message from the network device).

A total time (e.g., elapsed time) associated with the downlink transmissions M_{DL} can be determined as

$$10 {log}_{10} {\sum }_{i = 0}^{{M}_{D L}} {T}_{D , i} ,$$

where T_{D,i} is the time for the ith downlink reception. A total time (e.g., elapsed time) associated with the uplink transmissions M_{UL} can be determined as

$$10 {log}_{10} {\sum }_{i = 0}^{{M}_{U L}} {T}_{U , i} ,$$

where T_{U,i} is the time for the ith uplink transmission. P_{static} can represent the static discharge power of an energy storage element (e.g., battery, energy storage element 585, etc.) included in the energy harvesting device and/or can represent the static power consumption associated with synchronization signal block (SSB) or physical broadcast channel (PBCH) monitoring performed by the energy harvesting device. The parameter α can be used to represent full or partial pathloss (PL) compensation and P_{PL} can represent a downlink pathloss estimation determined by the energy harvesting device.

In some aspects, a network device (e.g., base station, gNB, etc.) associated with the energy harvesting device can configure one or more (or all) of the parameters included in Eq. (1). For example, the network device can generate and transmit ESI configuration information indicative of a quantity of downlink receptions (e.g., M_{DL}) and/or a quantity of uplink transmissions (e.g., M_{UL}) to be used by an energy harvesting device when determining its current energy headroom P_{EH} using Eq. (1). In some cases, the network device can generate and transmit ESI configuration information indicative of one or more reference signals that are to be used by the energy harvesting device for performing pathloss measurements or estimations (e.g., for determining the downlink pathloss estimate P_{PL} included in Eq. (1)).

In some aspects, one or more (or all) of the static discharge/power consumption value P_{static}, the instantaneous uplink transmission energy consumption P_{UL}, and/or the instantaneous downlink reception energy consumption P_{DL} can be signaled or otherwise indicated directly to the energy harvesting device by the network device. For example, one or more (or all) of the P_{static} value, the P_{UL} value, and/or the P_{DL} value can be determined by the network device based on a UE capability report transmitted by the energy harvesting device. In one illustrative example, the UE capability report may be indicative of a class or type of the energy harvesting device (e.g., passive energy harvesting device, semi-passive energy harvesting device, active energy harvesting device, active device without energy harvesting capabilities). In some examples, each different class or type of energy harvesting device may be associated with different P_{static}, P_{UL}, and P_{DL} values. In some cases, the network device can indicate the P_{static}, P_{UL}, and P_{DL} values to be used by a given energy harvesting device via one or more ESI configuration messages, as will be described in greater depth below.

In another illustrative example, the ESI information generated and transmitted by an energy harvesting device can be indicative of a calculated energy headroom that is based on a current conversion efficiency (e.g., of a rectifier or energy harvester of the energy harvesting device) during a configured time window (e.g., an ESI measurement window, etc.). For example, the ESI information can indicate the current energy headroom of a given energy harvesting device as:

$${P}_{E H} = {P}_{c u r r e n t} + {P}_{N} + 10 {log}_{10} ( T - {\sum }_{i = 0}^{{M}_{U L}} {T}_{U , i} ) - \{ {P}_{U L} + 10 {log}_{10} {\sum }_{i = 0}^{{M}_{U L}} {T}_{U , i} + α {P}_{P L} \} - \{ {P}_{D L} + 10 {log}_{10} {\sum }_{i = 0}^{{M}_{D L}} {T}_{D , i} + {P}_{s t a t i c} \} \qquad Eq . ( 2 )$$

Here, P_{current} is indicative of the currently stored energy associated with the energy harvesting device (e.g., as in Eq. (1), above). P_{IN} can represent the instantaneously harvested energy obtained by the energy harvesting device, wherein P_{IN} is based on a currently determined conversion efficiency associated with the energy harvesting device during the configured time window T. M_{DL} represents a total quantity of downlink transmissions over a given time window Tᵢ and M_{UL} represents a total quantity of uplink transmissions over the same given time window Tᵢ. P_{DL} can represent an instantaneous energy consumption associated with a downlink (DL) transmission received by the energy harvesting device and P_{UL} can represent an instantaneous energy consumption associated with an uplink (UL) transmission by the energy harvesting device (e.g., as in Eq. (1), above). The parameter α can be used to represent full or partial pathloss (PL) compensation and P_{PL} can represent a downlink pathloss estimation determined by the energy harvesting device.

In one illustrative example, the configured time window T associated with the energy headroom P_{EH} given by Eq. (2), above, can be the same as or similar to the ESI measurement window (e.g., as described previously above). In some aspects, the time window T (e.g., ESI measurement window) can be pre-configured at the energy harvesting device and/or signaled to the energy harvesting device using one or more ESI configuration messages. For example, a corresponding network device associated with the energy harvesting device can pre-configure the time window T (e.g., ESI measurement window) using one or more ESI configuration messages. In one illustrative example, the network device can use one or more Radio Resource Control (RRC) messages to pre-configure the time window T (e.g., ESI measurement window) for determining the current energy headroom P_{EH} of Eq. (2) at a given energy harvesting device. In some examples, the time window T (e.g., ESI measurement window) can be dynamically indicated by the network device to the energy harvesting device.

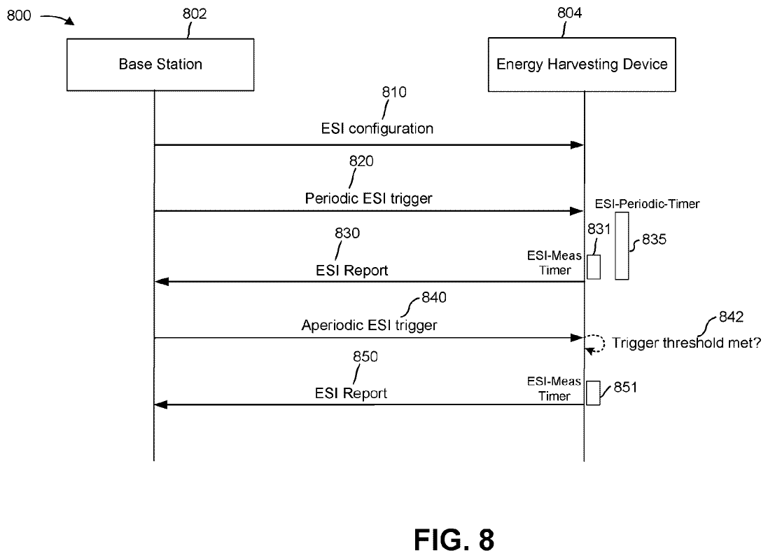

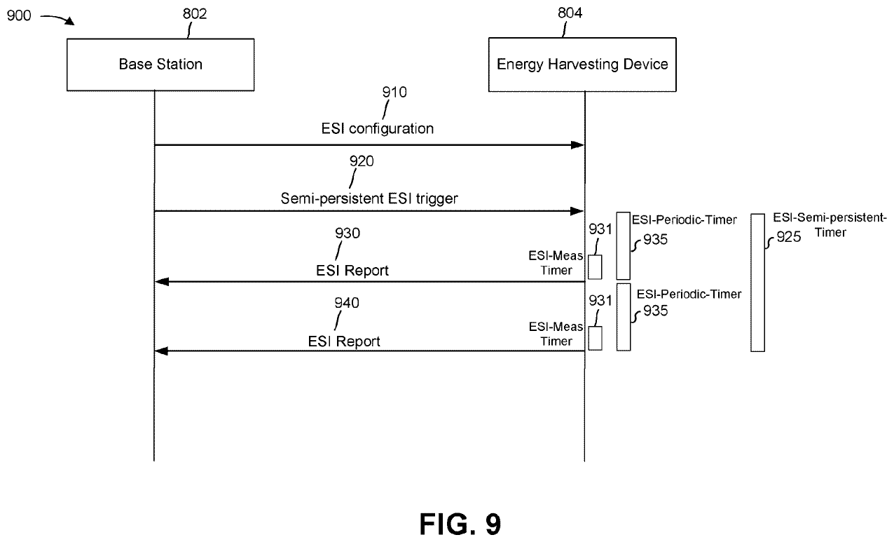

FIG. 8 is a diagram illustrating examples of periodic and aperiodic ESI reporting, in accordance with some examples. As described previously, ESI information and/or ESI reports can be transmitted by an energy harvesting device 804 to a base station 802 in a periodic and/or aperiodic report. Semi-persistent ESI reporting is described below with respect to FIG. 9. In some aspects, the energy harvesting device 804 can be the same as or similar to the energy harvesting device 500 illustrated in FIG. 5.

Base station 802 can transmit an ESI configuration 810 to energy harvesting device 804 that is indicative of one or more parameters for generating and transmitting ESI information and/or ESI reports at the energy harvesting device 804. For example, the ESI configuration 810 can indicate one or more configurations for how energy harvesting device 804 is to report ESI information, can indicate one or more formats associated with expected ESI information and/or ESI reports at the base station 802, and/or can indicate one or more resources for energy harvesting device 804 to use for reporting ESI information. In some cases, the ESI configuration 810 can indicate that L1, MAC-CE, and/or upper layer reporting should be utilized by the energy harvesting device 804 to transmit ESI information and/or ESI reports to the base station 802. In some examples, the ESI configuration 810 can include configuration information for one or more (or all) of a periodic ESI report, an aperiodic ESI report, and/or a semi-persistent ESI report, as will each be described in greater depth below. In some aspects, the ESI configuration 810 can be used to configure ESI reporting per band and/or to configure average ESI reporting across two or more bands. In some examples, the ESI configuration 810 can be indicative of or used to configure (e.g., at the energy harvesting device 804) one or more (or all) of an ESI latency bound, an ESI measurement window, and ESI periodic timer, etc.

In one illustrative example, base station 802 can configure the energy harvesting device 804 to generate and transmit a periodic ESI report. For example, ESI configuration 810 can indicate to energy harvesting device 804 that periodic ESI reporting should be performed. In some aspects, ESI configuration 810 can include an ESI-PeriodicTimer parameter to indicate a periodic reporting interval (e.g., a periodic reporting time) at which energy harvesting device 804 will generate and transmit a periodic ESI report. In some cases, the inclusion of an ESI-PeriodicTimer parameter value in the ESI configuration 810 can indicate that energy harvesting device 804 should transmit ESI information via periodic reporting. In some examples, an ESI-PeriodicTimer parameter value can be included in ESI configuration 810, with a separate message or separate parameter in the ESI configuration 810 used to trigger periodic ESI reporting by energy harvesting device 804. For example, in some cases base station 802 may generate and transmit a periodic ESI trigger 820 to energy harvesting device 804. Based on receiving the periodic ESI trigger 820, energy harvesting device 804 can perform periodic ESI reporting using the ESI-PeriodicTimer value. In some cases, the ESI-PeriodicTimer can be indicated in ESI configuration 810 and/or can be indicated in the periodic ESI trigger 820.

In one illustrative example, energy harvesting device 804 can trigger an ESI-Periodic-Timer 835 in response to receiving the periodic ESI trigger 820. The ESI-Periodic-Timer 835 may have a length equal to the ESI-PeriodicTimer parameter value configured by the base station 802. When the ESI-Periodic-Timer 835 expires, the energy harvesting device 804 can generate and transmit an ESI report to the network device 802. For example, when ESI-Periodic-Timer 835 expires, the energy harvesting device 804 can transmit an ESI report 830 to base station 802.

In some aspects, energy harvesting device 804 can perform periodic ESI reporting based on the ESI-Periodic-Timer 835 and based on an ESI-Measurement-Timer 831. The ESI-Measurement-Timer 831 can be the same as the ESI measurement window described previously above (e.g., representing the time resolution used by energy harvesting device 804 for reporting measured ESI information values). For example, the ESI report 830 can include ESI information based on measured values determined by energy harvesting device 804 within the ESI-Measurement-Timer window 831.

In some aspects, a periodicity used to perform periodic ESI reporting by the energy harvesting device 804 can be varied based on a current energy level of the energy harvesting device 804. For example, a periodic ESI reporting frequency (e.g., the length of ESI-Periodic-Timer 835) may be based on a stored energy level associated with energy harvesting device 804. In some cases, relatively infrequent ESI reporting may be performed when energy harvesting device 804 is associated with a high stored energy level (e.g., ESI-Periodic-Timer 835 may have a relatively large value). In some cases, relatively infrequent ESI reporting may additionally, or alternatively, be performed when energy harvesting device 804 is associated with a low stored energy level (e.g., ESI-Periodic-Timer 835 may have a relatively large value). In some examples, relatively frequent ESI reporting may be performed when energy harvesting device 804 is associated with a moderate to low stored energy level (e.g., ESI-Periodic-Timer 835 may have a relatively small value). In some cases, energy harvesting device 804 may skip one or more periodic ESI reports (e.g., may skip transmitting ESI report 830) based on determining that a current stored energy level associated with energy harvesting device 804 is greater than or equal to a pre-determined energy threshold. The pre-determined energy threshold can be pre-configured by the network device 802 using the ESI configuration 810 and/or may be dynamically indicated by network device 802 using the periodic ESI trigger 820.

In one illustrative example, base station 802 can configure the energy harvesting device 804 to generate and transmit an aperiodic ESI report. For example, ESI configuration 810 can indicate to energy harvesting device 804 that aperiodic ESI reporting should be performed. In some cases, aperiodic ESI reporting can be performed based on energy harvesting device 804 receiving an aperiodic ESI trigger 840 from base station 802. In some examples, energy harvesting device 804 may switch from periodic or semi-persistent ESI reporting to aperiodic ESI reporting, based on receiving aperiodic ESI trigger 840.

In some cases, ESI configuration 810 and/or aperiodic ESI trigger 840 can be indicative of one or more thresholds for energy harvesting device 804 to generate an transmit an aperiodic ESI report. For example, energy harvesting device 804 can determine a trigger threshold or aperiodic ESI reporting condition from one or more (or both) of the ESI configuration 810 and the aperiodic ESI trigger 840. The energy harvesting device 804 can evaluate the aperiodic trigger at 842 to determine whether an aperiodic ESI report should be generated and transmitted to base station 802. For example, the aperiodic trigger condition 842 may cause the energy harvesting device 804 to determine if the currently stored energy (e.g., at energy harvesting device 804) is less than or equal to a pre-defined and/or pre-configured threshold quantity. In some cases, the aperiodic trigger condition 842 may cause energy harvesting device 804 to compare its currently stored energy level to a pre-determined energy needed for uplink transmission. If energy harvesting device 804 determines that its currently stored energy level is below the threshold quantity of aperiodic trigger condition 842, energy harvesting device 804 can generate and transmit the aperiodic ESI report 850 to base station 802. In some cases, aperiodic ESI report 850 can be associated with measured values and/or ESI information determined by energy harvesting device 804 within the ESI measurement timer 851 corresponding to the ESI measurement window configured by base station 802 (e.g., via ESI configuration 810, aperiodic ESI trigger 840, etc.).

FIG. 9 is a diagram illustrating an example of semi-persistent ESI reporting, in accordance with some examples. As depicted in FIG. 9, base station 802 can generate and transmit an ESI configuration 910 to energy harvesting device 804. In some cases, ESI configuration 910 can be the same as or similar to ESI configuration 810 described with respect to FIG. 8. Base station 802 can generate and transmit a semi-persistent ESI trigger 920 to energy harvesting device 804. Based on receiving the semi-persistent ESI trigger 920, energy harvesting device 804 can generate and transmit ESI reports for a pre-determined period of time. In some cases, the semi-persistent ESI reporting time period can be indicated to energy harvesting device 804 using one or more of the ESI configuration 910 and the semi-persistent ESI trigger 920.

For example, based on receiving the semi-persistent ESI trigger 920, energy harvesting device 804 can perform periodic ESI reporting for a time window associated with an ESI-Semi-persistent-Timer 925. As illustrated, based on receiving semi-persistent ESI trigger 920, energy harvesting device 804 can begin ESI-Semi-persistent-Timer 925 (e.g., indicative of whether the semi-persistent ESI reporting period has expired) and can begin an ESI-Periodic-Timer 935 (e.g., indicative of whether the periodicity for transmitting the periodic ESI report has expired). In some cases, ESI-Periodic-Timer 935 can be the same as or similar to the ESI-Periodic-Timer 835 illustrated in FIG. 8.

As illustrated, when ESI-Periodic-Timer 935 initially expires after receiving the semi-persistent ESI trigger 920, energy harvesting device 804 can generate and transmit a first periodic ESI report 930 (e.g., which may be the same as or similar to the periodic ESI report 830 illustrated in FIG. 8). Based on the ESI-Semi-persistent-Timer 925 not yet having expired, energy harvesting device 804 can reset the ESI-Periodic-Timer 935 for a second periodic interval. When the second instance of ESI-Periodic-Timer 935 (e.g., begun when the first periodic ESI report 930 was transmitted) expires, energy harvesting device 804 can generate and transmit a second periodic ESI report 940. The second periodic ESI report 940 can be the same as or similar to one or more (or both) of the periodic ESI report 830 illustrated in FIG. 8 and the first periodic ESI report 930. Based on the ESI-Semi-persistent-Timer 925 having also expired, energy harvesting device 804 can cease performing semi-persistent ESI reporting after transmitting the second periodic ESI report 940 to base station 802. In some cases, one or more (or all) of the ESI reports generated during a semi-periodic ESI reporting session (e.g., associated with ESI-Semi-persistent-Timer 925) can be associated with a respective ESI-Measurement-Timer 931, which may be the same as or similar to the ESI-Measurement-Timers 831 and/or 851 illustrated in FIG. 8.

In some cases, energy harvesting device 804 can perform event-triggered ESI reporting. For example, base station 802 can generate and transmit ESI configuration information or messages (e.g., such as ESI configuration 810 and/or ESI configuration 910) indicative of one or more event-based triggers to be used by energy harvesting device 804. An event-based trigger can be associated with a type of ESI reporting to be performed by energy harvesting device 804 (e.g., periodic, aperiodic, semi-persistent, etc.). An event-based trigger may be further associated with one or more threshold values and/or conditions for energy harvesting device 804 to evaluate the event-based trigger. For example, an event-based trigger may indicate that energy harvesting device 804 can perform periodic ESI reporting if the current energy level of the energy harvesting device (e.g., the state of charge or stored energy associated with an energy storage element 585 included in the energy harvesting device) is below a first threshold or above a second threshold. Another event-based trigger may indicate that energy harvesting device 804 can perform aperiodic ESI reporting if the current energy level of the energy harvesting device is between the first and second thresholds.

In some aspects, ESI information and/or ESI reports generated and transmitted by an energy harvesting device can be received by one or more network devices (e.g., base stations, gNBs, etc.) associated with the energy harvesting device. The one or more network devices can determine an energy signal waveform to optimize or improve an energy conversion efficiency at the energy harvesting device and/or can determine an energy transfer duration for transmitting the energy signal waveform to the energy harvesting device. The energy signal waveform (e.g., energy signal waveform type) and energy transfer duration can be determined by the network device based on ESI information and/or ESI reports received from the energy harvesting device.

In one illustrative example, a first type of ESI information can be indicative of a lower or higher transmit power requested by an energy harvesting device. For example, the first type of ESI information (e.g., also referred to as “Type-0 ESI”) can be indicative of a request for an energy signal waveform having a greater RF power or a lesser RF power. In some cases, Type-0 ESI information can be transmitted by an energy harvesting device to a given network device associated with the energy harvesting device. For example, if the given network device has previously transmitted one or more energy signals received by the energy harvesting device, the energy harvesting device can generate and transmit, to the given network device, Type-0 ESI information indicative of a request for a higher or lower energy signal power relative to the one or more energy signal waveforms previously received by the energy harvesting device. In some aspects, the Type-0 ESI information request can be relative to a most recently received energy signal waveform transmitted by the same given network device. In some examples, the Type-0 ESI information request can be relative to multiple recently received energy signal waveforms transmitted by the same given network device. In some aspects, the Type-0 ESI information can include one or more identifiers or other information indicative of a previously received energy signal waveform for which the Type-0 ESI information was generated.

For example, Type-0 ESI can include a configured or pre-determined sequence to indicate that energy harvesting performed by the energy harvesting device requires higher or lower transmit power from the network device. In some cases, Type-0 ESI can include a configured or pre-determined sequence to indicate that energy harvesting performed by the energy harvesting device requires a different waveform to be used by the network device to transmit the energy signal. For example, Type-0 ESI information can be transmitted using one or more RRC messages. The Type-0 ESI information RRC message can indicate whether the sequence indicates energy harvesting that requires higher vs. lower transmit power or indicates a multi-sine waveform vs a single sine wave. In some examples, a Type-0 ESI information waveform switching indication can be based on a preferred frequency associated with the energy harvesting device. The preferred frequency can be previously indicated from the energy harvesting device to the network device during an initial connection process.

In another illustrative example, a second type of ESI information can be used to directly indicate whether to increase or decrease the transmit power of an energy signal waveform transmitted by a network device. For example, the second type of ESI information (e.g., also referred to as “Type-1 ESI”) can be indicative of a request to increase or decrease energy signal transmission power, using a multi-sine waveform or a single sine wave waveform. In some aspects, Type-1 ESI information can be indicated using one bit of information. For example, Type-1 ESI information can be indicated similar to physical uplink control channel (PUCCH) 1 formatted information. In some examples, a first value of the one information bit can be indicative of a request (e.g., from the energy harvesting device and/or to the network device) to increase the transmit power of an energy signal waveform and a second value of the one information bit can be indicative of a request to decrease the transmit power of the energy signal waveform. For example, a value of ‘1’ may indicate a request to increase transmit power and a value of ‘0’ may indicate a request to decrease transmit power.

In some aspects, Type-1 ESI information can be indicated using one or more sequence-based indications. For example, a Type-1 ESI information sequence-based indication may be the same as or similar to a PUCCH 0 format. In one illustrative example, one sequence can be utilized with two different (e.g., specified or pre-determined between the energy harvesting device and the network device) cyclic shifts. A first cyclic shift value of the sequence may be indicative of a request to increase transmit power of the energy signal waveform transmitted by the network device and a second cyclic shift value of the sequence may be indicative of a request to decrease the transmit power of the energy signal waveform transmitted by the network device. In examples wherein a Type-1 ESI information sequence-based indication is used as a waveform selection indication, a first cyclic shift value of the pre-determined sequence may be indicative of a request for the network device to transmit a multi-sine energy signal waveform and a second cyclic shift value of the pre-determined sequence may be indicative of a request for the network device to transmit a single sine wave energy signal waveform.

In some examples, the Type-1 ESI information cyclic shifts can be pre-determined between the network device (e.g., base station, gNB, etc.) and the energy harvesting device. For example, a base station can indicate one or more pre-determined cyclic shifts to one or more energy harvesting devices. Each energy harvesting device can use the same pre-determined cyclic shifts (e.g., determined based on ESI configuration information transmitted by the network device, such as ESI configuration 810 and/or 910) to indicate the same type of Type-1 ESI information (e.g., increase/decrease transmit power request, multi-sine waveform/assigned sine signal waveform, etc.). In such examples, the network device may further configure different uplink resources for receiving Type-1 ESI information from different energy harvesting devices.

In some aspects, a network device may utilize one or more RRC messages to configure different cyclic shifts to be used by different energy harvesting devices (e.g., a first energy harvesting device can be RRC configured to use a first set of cyclic shifts, a second energy harvesting device can be RRC configured to use a second set of cyclic shifts different than the first set of cyclic shifts, etc.). In some examples, the network device can dynamically indicate different cyclic shifts to different energy harvesting devices.

In some examples, an energy harvesting device can determine one or more cyclic shifts to be used in transmitting Type-1 ESI information to a network device. For example, the energy harvesting device can determine the one or more cyclic shifts based on an identifier associated with the energy harvesting device (e.g., a device ID). In some cases, the energy harvesting device can use its identifier as a lookup into a table or listing of pre-determined cyclic shift pairs. The table or listing of pre-determined cyclic shift pairs can be transmitted by the network device to the one or more energy harvesting devices via one or more ESI configuration messages.

In another illustrative example, a third type of ESI information can be indicative of an adjusted energy signal transmission power and waveform type selection or request associated with a given energy harvesting device. For example, the third type of ESI information (e.g., also referred to as “Type-2 ESI”) can include multiple bits that are indicative of the ESI information. In some aspects, multiple bits can be used to indicate an adjusted power requested by the energy harvesting device. For example, the multiple bits can be utilized to indicate an adjusted power request with a granularity given by (maximum varied power)/(2\hat{ }(quantity of multiple bits−1)). The maximum varied power can be the difference between the maximum and minimum transmit power that can be provided by the network device. In some examples, the maximum varied power can be the different between the maximum and minimum transmit power that can be received or utilized (e.g., for energy harvesting) at the energy harvesting device.

For example, for a maximum varied power Pₘₐₓ, if five bits are used to indicate Type-2 ESI information, the granularity of an adjusted power request associated with the energy harvesting device can be given as Pₘₐₓ/2⁴=Pₘₐₓ/16. In such an example, of the five bits available to indicate Type-2 ESI information, four bits can be used to indicate an adjusted power request. The remaining bit (e.g., first bit of the five-bit, multiple bit sequence) can be used to indicate whether the adjust power request is positive (e.g., increase transmit power of energy signal) or negative (e.g., decrease transmit power of energy signal). For example, a value of ‘0’ for the remaining or first bit of the multiple bit sequence can indicate a negative/decrease adjusted transmit power request and a value of ‘1’ can indicate a positive/increase adjusted transmit power request. In one illustrative example, a value of ‘00000’ can be used to indicate that the energy harvesting device is satisfied with the current energy signal transmit power received from the network device by the energy harvesting device. A value of ‘10010’ can be used to indicate an energy harvesting device request for the network device to increase the energy signal transmit power by 2*(Pₘₐₓ/16) (e.g., given in dB/μW/μJ). A value of ‘10011’ can be used to indicate an energy harvesting device request for the network device to increase the energy signal transmit power by 3*(Pₘₐₓ/16), etc.

In some examples, the multiple bits can be used to indicate an adjusted waveform requested by the energy harvesting device. For example, when the energy signal waveform transmitted by a network device (e.g., received by an energy harvesting device) is a multi-sine waveform, the energy harvesting device can use the multiple bits associated with Type-2 ESI information to indicate a type of filter that will be utilized for the multi-sine energy signal waveform. For example, the multiple-bit Type-2 ESI information can indicate a matched filter (e.g., match the amplitude and phase with the channel), can indicate a uniform power matched filter (e.g., match the phase with the channel while maintaining the same amplitude across the frequency/channels), etc. In some aspects, when the energy signal waveform transmitted by the network device is an assigned sine signal waveform, the energy harvesting device can use the multiple bits associated with the Type-2 ESI information to indicate a frequency that should be focused on or utilized for the assigned sine signal waveform transmitted by the network device.

In another illustrative example, the multiple bits included in Type-2 ESI information can indicate an adjusted transmit power request and an adjusted waveform type request associated with a given energy harvesting device (e.g., and a corresponding network device transmitting an energy signal to the given energy harvesting device). For example, a first portion (e.g., first subset) of the multiple Type-2 ESI information bits can be used to indicate a requested adjusted transmit power for the energy signal transmitted to the energy harvesting device by the network device, and a second portion (e.g., second subset) of the multiple Type-2 ESI information bits can be used to indicate a requested adjusted waveform type for the energy signal transmitted to the energy harvesting device by the network device.

In some aspects, a quantity of bits included in the multiple ESI Type-2 information bits can be pre-determined or otherwise configured by a network device (e.g., base station, gNB, etc.). For example, the quantity of bits to be included in ESI Type-2 information generated and transmitted by an energy harvesting device can be indicated using ESI configuration information or messages transmitted by the network device (e.g., received by the energy harvesting device). In some cases, the quantity of bits to be include in ESI Type-2 information can be indicated using ESI configuration information or messages that are the same as or similar to the ESI configuration 810 and/or the ESI configuration 910, illustrated in FIGS. 8 and 9 respectively.

In one illustrative example, an energy harvesting device can be configured to report one or more of Type-0, Type-1, and/or Type-2 ESI information. For example, a network device (e.g., base station, gNB, etc.) can use one or more ESI configuration messages to configure an energy harvesting device to generate and transmit ESI reports that include Type-0, Type-1, and/or Type-2 ESI information. In some cases, one or more RRC configurations can be used to indicate the format and/or resource(s) of each type of ESI information.

For example, an RRC configuration can be utilized for ESI resources, priority, formats, etc. In some aspects, an ESI-Resource RRC configuration can be given as:

| ESI-Resource ::= SEQUENCE { | |
|---|---|
| ESI-ResourceID | PUCCH-ResourceID, |
| startingPRB | PRB-ID, |
| format | CHOICE{ |
| format0 | ESI-type0, |
| format1 | ESI-type1, |
| format2 | ESI-type2}} |

In some aspects, an ESI-type0 RRC configuration can be given as:

ESI-type0 ::= SEQUENCE {

| | |
|---|---|
| initialCyclicShift | INTEGER(0 . . . N₀), |
| nrOfSymbols | INTEGER(1 . . . X₀), |
| startingSymbolIndex | INTEGER(0 . . . M₀), |
| BackscatterOnlyEnabled | ENUMERATED{enabled} |
| PriorityIndex | ENUMERATED{P₀, P₁, . . . , Pₙ}} |

In some aspects, an ESI-type1 RRC configuration can be given as:

| ESI-type1 ::= SEQUENCE { | |
|---|---|
| initialCyclicShift | INTEGER(0 . . . N₁), |
| nrOfSymbols | INTEGER(1 . . . X₁) |
| startingSymbol Index | INTEGER(0 . . . M₁), |
| timeDomainOCC | INTEGER(0 . . . 6) |
| PriorityIndex | ENUMERATED{P₀, P₁, . . . Pₙ}} |

In some aspects, an ESI-type2 RRC configuration can be given as:

| ESI-type2 ::= SEQUENCE { | |
|---|---|
| nrOfPRBs | INTEGER(0 . . . N₂), |
| nrOfSymbols | INTEGER(1 . . . X₂), |
| startingSymbolIndex | INTEGER(0 . . . M₂), |
| PriorityIndex | ENUMERATED{P₀, P₁, . . . Pₙ}} |

In some examples, one or more configured ESI resources may be overlapped in time. For example, overlapped configured ESI resources may be indicative of the same type of ESI information (e.g., Type-0 ESI, Type-1 ESI, Type-2 ESI) and/or the same ESI information values (e.g., transmit power, waveform, etc.).

In one illustrative example, when configured ESI resources are overlapped in time, a network device can cause the ESI (e.g., of the overlapping, configured ESI resources) which has a low load or lowest load to be transmitted by the corresponding energy harvesting device. In some examples, the network device can cause the ESI (e.g., of the overlapping, configured ESI resources) having the highest priority based on an ESI configuration information to be transmitted by the corresponding energy harvesting device.

In some aspects, overlapping configured ESI resources may be used to indicate different types of ESI information and/or different ESI information values (e.g., one of the overlapping configured ESI resources is used to indicate energy status or a transmitted power indication, and a second of the overlapping configured ESI resources is used to indicate a waveform selection). In some cases, if the energy harvesting device has not been configured to transmit multiple types of ESI information using the same resource, then the energy harvesting device may only transmit the ESI (e.g., the ESI type of the multiple types of ESI) having the highest priority. Relative prioritization of ESI types can be configured by the network device using one or more ESI configuration messages. For example, energy status ESI information can be configured with a higher relative priority than waveform type selection ESI information, etc.

In some examples, an energy harvesting device may be configured to transmit multiple types of ESI information using a same resource. For example, an energy harvesting device may be configured (e.g., by a network device and/or by ESI configuration information messages) with a SimultaneousES-WS parameter enabled. In one illustrative example, if there are two Type-0 ESIs overlapped in time, the energy harvesting device can use different cyclic shifts to indicate information associated with the overlapping ESIs. For example, different cyclic shifts can be used to indicate whether the two overlapping Type-0 ESIs are both energy status indications, are both waveform selection indications, are a combination of energy status and waveform selection indications, etc.

In some aspects, for one Type-0 ESI and one Type-1 ESI that are overlapped in time, the energy harvesting device can be configured (e.g., by the network device and/or one or more ESI configuration messages) to transmit the Type-0 and Type-1 ESI using the same resource. For example, the energy harvesting device can transmit the Type-1 ESI using the configured resource for the Type-0 ESI (e.g., both the Type-1 ESI and the Type-0 ESI can be transmitted using the configured resource associated with the Type-0 ESI).

In some aspects, for two Type-2 ESIs that are overlapped in time, the energy harvesting device can be configured (e.g., by the network device and/or one or more ESI configuration messages) to transmit all of the overlapping ESI information using a selected one of the overlapping, configured resources. For example, the overlapping Type-2 ESIs can be transmitted using a selected one of the overlapping, configured resources that is able to carry all of the overlapping Type-2 ESI information. In one illustrative example, if O_{ESI_1} indicates the length of information at a first ESI resource ESI_1 and O_{ESI_2} indicates the length of information at a second ESI resource ESI_2, the energy harvesting device can transmit the overlapping ESI information using a selected one of the overlapping, configured ESI resources that has a length greater that O_{ESI_1}+O_{ESI_2}+O_{CRC}, where O_{CRC} represents a default cyclic redundancy check (CRC) length in PUCCH or PDCCH.

In some aspects, an energy harvesting device can transmit ESI information (e.g., to a network device associated with the energy harvesting device) based on ESI configuration information and/or one or more locally determined parameters associated with the energy harvesting device. In some examples, an energy harvesting device can determine one or more available resources for transmitting ESI information and/or ESI reports to the network device. For example, in some cases an energy harvesting device can use a configured periodic resource to transmit ESI information and/or ESI reports.

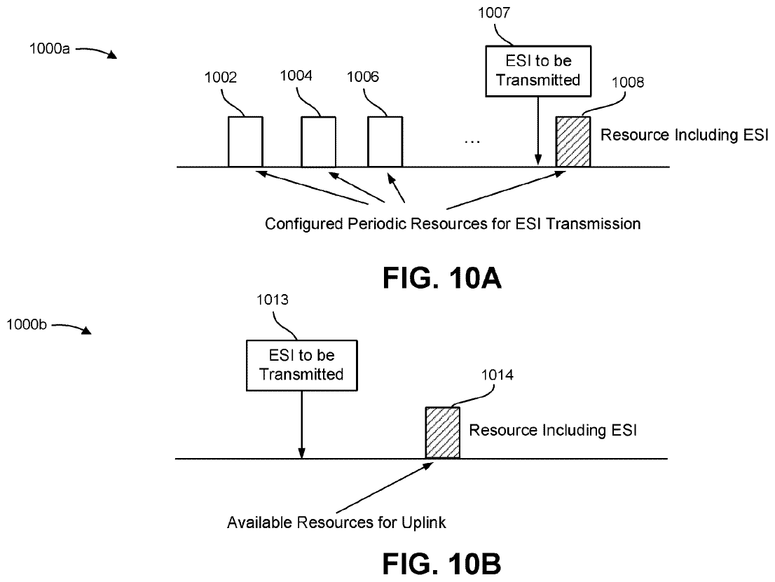

FIG. 10A is a diagram illustrating an example of ESI reporting using dedicated periodic resources, in accordance with some examples. In some aspects, dedicated periodic resources can be configured by a network device (e.g., base station or gNB) and used to transmit Type-0, Type-1, and/or Type-2 ESI information. For example, a plurality of resources 1002, 1004, 1006, . . . 1008 can be configured by the network device for use by the energy harvesting device in transmitting ESI information and/or ESI reports. In some cases, a configured resource may go unused by an energy harvesting device based on the energy harvesting device determining that its current energy harvesting status information meets or satisfies (e.g., is greater than) all ESI reporting thresholds configured or otherwise indicated to the energy harvesting device by the network device. For example, if the energy harvesting device determines that its current energy harvesting status can remain unchanged, and that a current energy level associated with an energy storage element included in the energy harvesting device is greater than an energy threshold, the energy harvesting device may skip ESI reporting.

For example, a given energy harvesting device may skip ESI reporting using the configured resources 1002, 1004, and 1006, based on then energy harvesting device determining that its current energy harvesting status has not triggered one or more ESI reporting conditions configured at the energy harvesting device by the network device. When the network device (e.g., base station, gNB, etc.) does not receive an ESI information report on the configured resources 1002, 1004, or 1006, in each instance the network device can determine that the energy harvesting device associated with the configured resources 1002-1006 can continue to receive an energy signal transmission without any changes or modifications to the energy signal transmit power, waveform, etc. (e.g., the network device may determine that the energy harvesting device is satisfied with the current energy signal transmitted by the network device, based on the network device not receiving ESI information reporting on any of the configured periodic resources 1002-1006). If the energy harvesting device determines at a later time that an ESI report 1007 should be transmitted to the network device (e.g., based on the energy harvesting device determining that one or more ESI reporting conditions or triggers have been met), the energy harvesting device can transmit the ESI report 1007 using the next available configured periodic ESI resource 1008.

In some aspects, ESI information reporting can be performed without using dedicated resources for carrying ESI information and/or ESI reports. For example, FIG. 10B is a diagram illustrating an example of ESI reporting based on using a next available resource, in accordance with some examples. In one illustrative example, an energy harvesting device may determine that an ESI report 1013 should be transmitted to the network device (e.g., based on the energy harvesting device determining that one or more ESI reporting conditions or triggers have been met). After determining that ESI report 1013 should be transmitted (e.g., reported) to the network device, the energy harvesting device can use the nearest available uplink resource 1014 to transmit the ESI report 1013 to the network device.

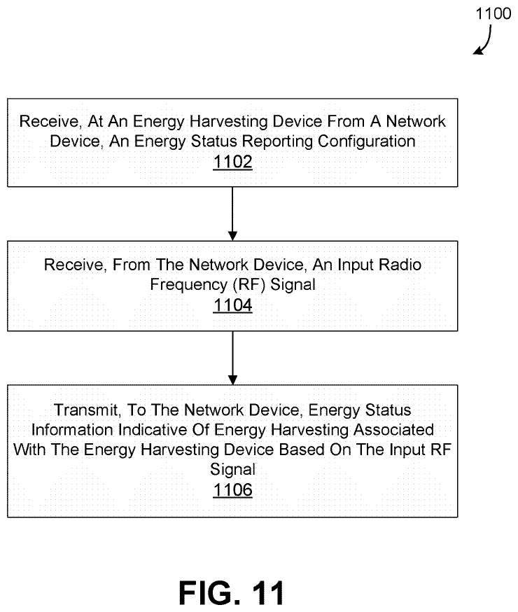

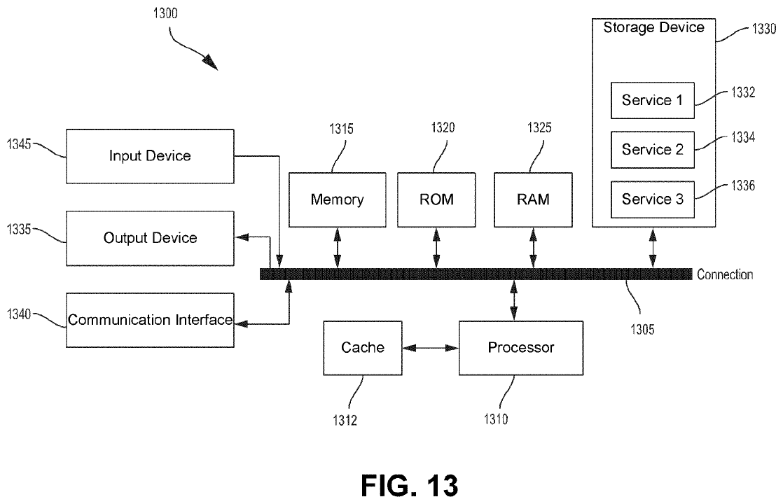

FIG. 11 is a flowchart diagram illustrating an example of a process 1100 for wireless communications. The process 1100 may be performed by an energy harvesting device (e.g., the energy harvesting device 804 of FIG. 8 and/or FIG. 9) or by a component or system (e.g., a chipset) of the energy harvesting device. In some examples, the process 1100 may be performed by a UE and/or an energy harvesting device. In some cases, the UE can be an energy harvesting device. The operations of the process 1100 may be implemented as software components that are executed and run on one or more processors (e.g., processor 1310 of FIG. 13 or other processor(s)). Further, the transmission and reception of signals by the energy harvesting device in the process 1100 may be enabled, for example, by one or more antennas and/or one or more transceivers (e.g., antenna(s) and/or wireless transceiver(s) of any of FIG. 2, FIG. 4, FIG. 5, etc.).

At block 1102, the energy harvesting device (or component thereof) can receive, from a network device, an energy status reporting configuration. The network device can include any type of network device, such as a base station (e.g., the base station 102 of FIG. 1 and/or FIG. 2, the disaggregated base station 300 of FIG. 4, the base station 802 of FIG. 8 and/or FIG. 9), a portion of the base station (e.g., the CU 310, the DU 330, the RU 340, the Near-RT RIC 325, the Non-RT RIC 315, and/or or other portion of the disaggregated base station 300), or other type of network device.

At block 1104, the energy harvesting device (or component thereof) can receive, at the energy harvesting device from the network device, an input radio frequency (RF) signal. At block 1106, the energy harvesting device (or component thereof) can transmit, from the energy harvesting device to the network device, energy status information indicative of energy harvesting associated with the energy harvesting device based on the input RF signal.

In some cases, the energy status reporting configuration is indicative of an energy status measurement window and a reporting format associated with the energy status measurement window. In such aspects, the energy harvesting device (or component thereof) can generate the energy status information using the energy status measurement window and the reporting format.

In some aspects, the energy status information is indicative of a conversion efficiency associated with a rectifier included in an energy harvester of the energy harvesting device, an input power associated with the rectifier, an output power associated with the rectifier, an operating zone of the rectifier, any combination thereof, and/or other information.

In some aspects, the energy status information is indicative of a stored energy associated with the energy harvesting device and/or an energy headroom associated with the energy harvesting device. In some cases, the energy status reporting configuration is indicative of one or more energy status reporting thresholds. In such cases, the energy harvesting device (or component thereof) can transmit the energy status information based on a determination that at least one of the stored energy or the energy headroom is less than at least one of the one or more energy status reporting thresholds. In some examples, the energy harvesting device (or component thereof) can determine the energy headroom based on a difference between the stored energy associated with the energy harvesting device and a maximum energy associated with the energy harvesting device. In some cases, the energy harvesting device (or component thereof) can determine an instantaneously harvested energy obtained from the input RF signal using an energy harvester included in the energy harvesting device. The energy harvesting device (or component thereof) can determine the energy headroom further based on at least one of the instantaneously harvested energy or an energy harvesting efficiency associated with the energy harvester. In some aspects, the energy status reporting configuration includes one or more parameters for determining the instantaneously harvested energy obtained from the input RF signal.

In some cases, the energy status reporting configuration is indicative of a periodic reporting interval. In such cases, the energy harvesting device (or component thereof) can transmit the energy status information based on the periodic reporting interval.

In some aspects, to transmit the energy status information, the energy harvesting device (or component thereof) can receive, from the network device, an energy status reporting trigger indicative of one or more energy status conditions. The energy harvesting device (or component thereof) can compare a current energy status of the energy harvesting device to the one or more energy status conditions. The energy harvesting device (or component thereof) can transmit, to the network device, the energy status information based on the energy status reporting trigger. In some cases, the energy status reporting trigger is an aperiodic reporting trigger or a semi-persistent reporting trigger.

In some aspects, the energy status information is indicative of an adjusted transmit power request associated with the input RF signal and/or an adjusted waveform type request associated with the input RF signal. In some cases, the adjusted transmit power request is a request to increase transmit power or a request to decrease transmit power. In some cases, the adjusted waveform type request is a request for a multi-sine input RF signal waveform or a request for an assigned sine signal input RF signal waveform. In some examples, the energy harvesting device (or component thereof) can receive, from the network device, a second input RF signal. In some cases, a power of the second input RF signal is associated with the adjusted transmit power request. In some aspects, the adjusted transmit power request is indicated based on a pre-determined sequence. In some cases, the pre-determined sequence is determined based on the energy status reporting configuration.

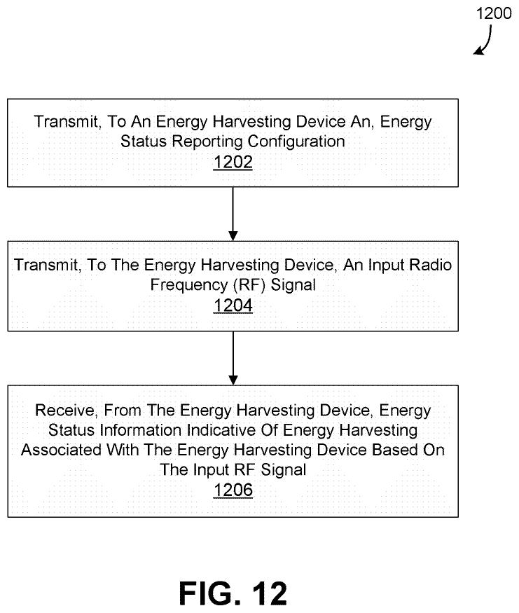

FIG. 12 is a flowchart diagram illustrating an example of a process 1200 for wireless communications. The process 1200 may be performed by a network device or by a component or system (e.g., a chipset) of the network device. In some examples, the network device is a base station (e.g., the base station 102 of FIG. 1 and/or FIG. 2, the disaggregated base station 300 of FIG. 4, the base station 802 of FIG. 8 and/or FIG. 9) or a portion of the base station (e.g., the CU 310, the DU 330, the RU 340, the Near-RT RIC 325, the Non-RT RIC 315, and/or or other portion of the disaggregated base station 300). The operations of the process 1200 may be implemented as software components that are executed and run on one or more processors (e.g., processor 1310 of FIG. 13 or other processor(s)). Further, the transmission and reception of signals by the network device in the process 1200 may be enabled, for example, by one or more antennas and/or one or more transceivers (e.g., antenna(s) and/or wireless transceiver(s) of any of FIG. 2, FIG. 4, FIG. 5, etc.).

At block 1202, the network device (or component thereof) can transmit, to an energy harvesting device an, energy status reporting configuration. In one illustrative example, the energy harvesting device can be the energy harvesting device 804 of FIG. 8 and/or FIG. 9.

At block 1204, the network device (or component thereof) can transmit, to the energy harvesting device, an input radio frequency (RF) signal. At block 1206, the network device (or component thereof) can receive, from the energy harvesting device, energy status information indicative of energy harvesting associated with the energy harvesting device based on the input RF signal.

In some cases, the energy status reporting configuration is indicative of an energy status measurement window and a reporting format associated with the energy status measurement window. In such cases, the energy status information can be based on the energy status measurement window and the reporting format.

In some aspects, the energy status information is indicative of a conversion efficiency associated with a rectifier included in an energy harvester of the energy harvesting device, an input power associated with the rectifier, an output power associated with the rectifier, an operating zone of the rectifier, any combination thereof, and/or other information.

In some aspects, the energy status information is indicative of a stored energy associated with the energy harvesting device and/or an energy headroom associated with the energy harvesting device. In some cases, the energy status reporting configuration is indicative of one or more energy status reporting thresholds. As noted above, the energy harvesting device can transmit the energy status information to the network device based on a determination that at least one of the stored energy or the energy headroom is less than at least one of the one or more energy status reporting thresholds.

In some cases, the energy status reporting configuration is indicative of a periodic reporting interval. In such cases, the energy harvesting device (or component thereof) can transmit the energy status information based on the periodic reporting interval.

In some aspects, the energy status information is indicative of an adjusted transmit power request associated with the input RF signal and/or an adjusted waveform type request associated with the input RF signal. In some cases, the adjusted transmit power request is a request to increase transmit power or a request to decrease transmit power. In some cases, the adjusted waveform type request is a request for a multi-sine input RF signal waveform or a request for an assigned sine signal input RF signal waveform. In some examples, the network device (or component thereof) can transmit, to the energy harvesting device, a second input RF signal. In some cases, a power of the second input RF signal is associated with the adjusted transmit power request. In some aspects, the adjusted transmit power request is indicated based on a pre-determined sequence. In some cases, the pre-determined sequence is determined based on the energy status reporting configuration.

In some examples, the processes described herein (e.g., process 1100, process 1200, and/or other process described herein) may be performed by a computing device or apparatus (e.g., a network node such as a UE, base station, a portion of a base station, etc.). For example, as noted above, the process 1100 may be performed by a UE and/or an energy harvesting device. In some examples, the process 1100 may be performed by an energy harvesting device with an architecture that is the same as or similar to the energy harvesting device architecture shown in FIG. 5. As further noted above, the process 1200 may be performed by a base station (e.g., the base station 102 of FIG. 1 and/or FIG. 2, the disaggregated base station 300 of FIG. 4, the base station 802 of FIG. 8 and/or FIG. 9) or a portion of the base station (e.g., the CU 310, the DU 330, the RU 340, the Near-RT RIC 325, the Non-RT RIC 315, and/or or other portion of the disaggregated base station 300).

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the WiFi (802.11x) standards, data according to the Bluetooth™ standard, data according to the Internet Protocol (IP) standard, and/or other types of data.

The components of the computing device may be implemented in circuitry. For example, the components may include and/or may be implemented using electronic circuits or other electronic hardware, which may include one or more programmable electronic circuits (e.g., microprocessors, graphics processing units (GPUs), digital signal processors (DSPs), central processing units (CPUs), and/or other suitable electronic circuits), and/or may include and/or be implemented using computer software, firmware, or any combination thereof, to perform the various operations described herein.

The process 1100 and the process 1200 are illustrated as a logical flow diagram, the operation of which represent a sequence of operations that may be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations may be combined in any order and/or in parallel to implement the processes.

Additionally, the process 1100, the process 1200, and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 13 is a diagram illustrating an example of a system for implementing certain aspects of the present technology. In particular, FIG. 13 illustrates an example of computing system 1300, which may be for example any computing device making up internal computing system, a remote computing system, a camera, or any component thereof in which the components of the system are in communication with each other using connection 1305. Connection 1305 may be a physical connection using a bus, or a direct connection into processor 1310, such as in a chipset architecture. Connection 1305 may also be a virtual connection, networked connection, or logical connection.

In some aspects, computing system 1300 is a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

Example system 1300 includes at least one processing unit (CPU or processor) 1310 and connection 1305 that communicatively couples various system components including system memory 1315, such as read-only memory (ROM) 1320 and random access memory (RAM) 1325 to processor 1310. Computing system 1300 may include a cache 1315 of high-speed memory connected directly with, in close proximity to, or integrated as part of processor 1310.

Processor 1310 may include any general-purpose processor and a hardware service or software service, such as services 1332, 1334, and 1336 stored in storage device 1330, configured to control processor 1310 as well as a special-purpose processor where software instructions are incorporated into the actual processor design. Processor 1310 may essentially be a completely self-contained computing system, containing multiple cores or processors, a bus, memory controller, cache, etc. A multi-core processor may be symmetric or asymmetric.

To enable user interaction, computing system 1300 includes an input device 1345, which may represent any number of input mechanisms, such as a microphone for speech, a touch-sensitive screen for gesture or graphical input, keyboard, mouse, motion input, speech, etc. Computing system 1300 may also include output device 1335, which may be one or more of a number of output mechanisms. In some instances, multimodal systems may enable a user to provide multiple types of input/output to communicate with computing system 1300.

Computing system 1300 may include communications interface 1340, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB), port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1340 may also include one or more Global Navigation Satellite System (GNSS) receivers or transceivers that are used to determine a location of the computing system 1300 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1330 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1330 may include software services, servers, services, etc., that when the code that defines such software is executed by the processor 1310, it causes the system to perform a function. In some aspects, a hardware service that performs a particular function may include the software component stored in a computer-readable medium in connection with the necessary hardware components, such as processor 1310, connection 1305, output device 1335, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B.

Illustrative aspects of the disclosure include:

Aspect 1. An energy harvesting device for wireless communications, comprising: at least one memory; and at least one processor coupled to the at least one memory, the at least one processor configured to: receive, from a network device, an energy status reporting configuration; receive, from the network device, an input radio frequency (RF) signal; and transmit, to the network device, energy status information indicative of energy harvesting associated with the energy harvesting device based on the input RF signal.

Aspect 2. The energy harvesting device of Aspect 1, wherein the energy status information is indicative of at least one of a conversion efficiency associated with a rectifier included in an energy harvester of the energy harvesting device, an input power associated with the rectifier, an output power associated with the rectifier, or an operating zone of the rectifier.

Aspect 3. The energy harvesting device of any one of Aspects 1 or 2, wherein: the energy status reporting configuration is indicative of an energy status measurement window and a reporting format associated with the energy status measurement window; and the at least one processor is configured to generate the energy status information using the energy status measurement window and the reporting format.

Aspect 4. The energy harvesting device of any one of Aspects 1 to 3, wherein the energy status information is further indicative of at least one of a stored energy associated with the energy harvesting device or an energy headroom associated with the energy harvesting device.

Aspect 5. The energy harvesting device of Aspect 4, wherein: the energy status reporting configuration is indicative of one or more energy status reporting thresholds; and the at least one processor is configured to transmit the energy status information based on a determination that at least one of the stored energy or the energy headroom is less than at least one of the one or more energy status reporting thresholds.

Aspect 6. The energy harvesting device of any one of Aspects 4 or 5, wherein the at least one processor is further configured to: determine the energy headroom based on a difference between the stored energy associated with the energy harvesting device and a maximum energy associated with the energy harvesting device.

Aspect 7. The energy harvesting device of Aspect 6, wherein the at least one processor is further configured to: determine an instantaneously harvested energy obtained from the input RF signal using an energy harvester included in the energy harvesting device; and determine the energy headroom further based on at least one of the instantaneously harvested energy or an energy harvesting efficiency associated with the energy harvester.

Aspect 8. The energy harvesting device of Aspect 7, wherein the energy status reporting configuration includes one or more parameters for determining the instantaneously harvested energy obtained from the input RF signal.

Aspect 9. The energy harvesting device of any one of Aspects 1 to 8, wherein: the energy status reporting configuration is indicative of a periodic reporting interval; and the at least one processor is configured to transmit the energy status information based on the periodic reporting interval.

Aspect 10. The energy harvesting device of any one of Aspects 1 to 9, wherein, to transmit the energy status information, the at least one processor is configured to: receive, from the network device, an energy status reporting trigger indicative of one or more energy status conditions; compare a current energy status of the energy harvesting device to the one or more energy status conditions; and transmit, to the network device, the energy status information based on the energy status reporting trigger.

Aspect 11. The energy harvesting device of Aspect 10, wherein the energy status reporting trigger is an aperiodic reporting trigger or a semi-persistent reporting trigger.

Aspect 12. The energy harvesting device of any one of Aspects 1 to 11, wherein the energy status information is indicative of at least one of an adjusted transmit power request associated with the input RF signal or an adjusted waveform type request associated with the input RF signal.

Aspect 13. The energy harvesting device of Aspect 12, wherein the adjusted transmit power request is a request to increase transmit power or a request to decrease transmit power.

Aspect 14. The energy harvesting device of any one of Aspects 12 or 13, wherein the adjusted waveform type request is a request for a multi-sine input RF signal waveform or a request for an assigned sine signal input RF signal waveform.

Aspect 15. The energy harvesting device of any one of Aspects 12 to 14, wherein the at least one processor is further configured to: receive, from the network device, a second input RF signal, wherein a power of the second input RF signal is associated with the adjusted transmit power request.

Aspect 16. The energy harvesting device of any one of Aspects 12 to 15, wherein the adjusted transmit power request is indicated based on a pre-determined sequence, wherein the pre-determined sequence is determined based on the energy status reporting configuration.

Aspect 17. A method of wireless communications performed at an energy harvesting device, the method comprising: receiving, at the energy harvesting device from a network device, an energy status reporting configuration; receiving, at the energy harvesting device from the network device, an input radio frequency (RF) signal; and transmitting, from the energy harvesting device to the network device, energy status information indicative of energy harvesting associated with the energy harvesting device based on the input RF signal.

Aspect 18. The method of Aspect 17, wherein the energy status information is indicative of at least one of a conversion efficiency associated with a rectifier included in an energy harvester of the energy harvesting device, an input power associated with the rectifier, an output power associated with the rectifier, or an operating zone of the rectifier.

Aspect 19. The method of any one of Aspects 17 or 18, wherein the energy status reporting configuration is indicative of an energy status measurement window and a reporting format associated with the energy status measurement window, and wherein the method further comprises: generating the energy status information using the energy status measurement window and the reporting format.

Aspect 20. The method of any one of Aspects 17 to 19, wherein the energy status information is further indicative of at least one of a stored energy associated with the energy harvesting device or an energy headroom associated with the energy harvesting device.

Aspect 21. The method of Aspect 20, wherein the energy status reporting configuration is indicative of one or more energy status reporting thresholds, and wherein the method further comprises: transmitting the energy status information based on a determination that at least one of the stored energy or the energy headroom is less than at least one of the one or more energy status reporting thresholds.

Aspect 22. The method of any one of Aspects 20 or 21, further comprising: determining the energy headroom based on a difference between the stored energy associated with the energy harvesting device and a maximum energy associated with the energy harvesting device.

Aspect 23. The method of Aspect 22, further comprising: determining an instantaneously harvested energy obtained from the input RF signal using an energy harvester included in the energy harvesting device; and determining the energy headroom further based on at least one of the instantaneously harvested energy or an energy harvesting efficiency associated with the energy harvester.

Aspect 24. The method of Aspect 23, wherein the energy status reporting configuration includes one or more parameters for determining the instantaneously harvested energy obtained from the input RF signal.

Aspect 25. The method of any one of Aspects 17 to 24, wherein the energy status reporting configuration is indicative of a periodic reporting interval, and wherein the method further comprises: transmitting the energy status information based on the periodic reporting interval.

Aspect 26. The method of any one of Aspects 17 to 25, wherein transmitting the energy status information comprises: receiving, from the network device, an energy status reporting trigger indicative of one or more energy status conditions; comparing a current energy status of the energy harvesting device to the one or more energy status conditions; and transmitting, to the network device, the energy status information based on the energy status reporting trigger.

Aspect 27. The method of Aspect 26, wherein the energy status reporting trigger is an aperiodic reporting trigger or a semi-persistent reporting trigger.

Aspect 28. The method of any one of Aspects 17 to 27, wherein the energy status information is indicative of at least one of an adjusted transmit power request associated with the input RF signal or an adjusted waveform type request associated with the input RF signal.

Aspect 29. The method of Aspect 28, wherein the adjusted transmit power request is a request to increase transmit power or a request to decrease transmit power.

Aspect 30. The method of any one of Aspects 28 or 29, wherein the adjusted waveform type request is a request for a multi-sine input RF signal waveform or a request for an assigned sine signal input RF signal waveform.

Aspect 31. The method of any one of Aspects 28 to 30, further comprising: receiving, from the network device, a second input RF signal, wherein a power of the second input RF signal is associated with the adjusted transmit power request.

Aspect 32. The method of any one of Aspects 28 to 31, wherein the adjusted transmit power request is indicated based on a pre-determined sequence, wherein the pre-determined sequence is determined based on the energy status reporting configuration.

Aspect 33. A network device for wireless communications, comprising: at least one memory; and at least one processor coupled to the at least one memory, the at least one processor configured to: transmit, to an energy harvesting device, an energy status reporting configuration; transmit, to the energy harvesting device, an input radio frequency (RF) signal; and receive, from the energy harvesting device, energy status information indicative of energy harvesting associated with the energy harvesting device based on the input RF signal.

Aspect 34. The network device of Aspect 33, wherein the energy status information is indicative of at least one of a conversion efficiency associated with a rectifier included in an energy harvester of the energy harvesting device, an input power associated with the rectifier, an output power associated with the rectifier, or an operating zone of the rectifier.

Aspect 35. The network device of any one of Aspects 33 or 34, wherein: the energy status reporting configuration is indicative of an energy status measurement window and a reporting format associated with the energy status measurement window; and the energy status information is based on the energy status measurement window and the reporting format.

Aspect 36. The network device of any one of Aspects 33 to 35, wherein the energy status information is further indicative of at least one of a stored energy associated with the energy harvesting device or an energy headroom associated with the energy harvesting device.

Aspect 37. The network device of any one of Aspects 33 to 36, wherein the energy status reporting configuration is indicative of one or more energy status reporting thresholds.

Aspect 38. The network device of any one of Aspects 33 to 37, wherein the energy status reporting configuration is indicative of a periodic reporting interval.

Aspect 39. The network device of any one of Aspects 33 to 38, wherein the energy status information is indicative of at least one of an adjusted transmit power request associated with the input RF signal or an adjusted waveform type request associated with the input RF signal.

Aspect 40. The network device of Aspect 39, wherein the adjusted transmit power request is a request to increase transmit power or a request to decrease transmit power.

Aspect 41. The network device of any one of Aspects 39 or 40, wherein the adjusted waveform type request is a request for a multi-sine input RF signal waveform or a request for an assigned sine signal input RF signal waveform.

Aspect 42. The network device of any one of Aspects 39 to 41, wherein the at least one processor is further configured to: transmit, to the energy harvesting device, a second input RF signal, wherein a power of the second input RF signal is associated with the adjusted transmit power request.

Aspect 43. The network device of any one of Aspects 39 to 42, wherein the adjusted transmit power request is indicated based on a pre-determined sequence, wherein the pre-determined sequence is determined based on the energy status reporting configuration.

Aspect 44. A method of wireless communications at a network device, the method comprising: transmitting, to an energy harvesting device an, energy status reporting configuration; transmitting, to the energy harvesting device, an input radio frequency (RF) signal; and receiving, from the energy harvesting device, energy status information indicative of energy harvesting associated with the energy harvesting device based on the input RF signal.

Aspect 45. The method of Aspect 44, wherein the energy status information is indicative of at least one of a conversion efficiency associated with a rectifier included in an energy harvester of the energy harvesting device, an input power associated with the rectifier, an output power associated with the rectifier, or an operating zone of the rectifier.

Aspect 46. The method of any one of Aspects 44 or 45, wherein: the energy status reporting configuration is indicative of an energy status measurement window and a reporting format associated with the energy status measurement window; and the energy status information is based on the energy status measurement window and the reporting format.

Aspect 47. The method of any one of Aspects 44 to 46, wherein the energy status information is further indicative of at least one of a stored energy associated with the energy harvesting device or an energy headroom associated with the energy harvesting device.

Aspect 48. The method of any one of Aspects 44 to 47, wherein the energy status reporting configuration is indicative of one or more energy status reporting thresholds.

Aspect 49. The method of any one of Aspects 44 to 48, wherein the energy status reporting configuration is indicative of a periodic reporting interval.

Aspect 50. The method of any one of Aspects 44 to 49, wherein the energy status information is indicative of at least one of an adjusted transmit power request associated with the input RF signal or an adjusted waveform type request associated with the input RF signal.

Aspect 51. The method of Aspect 50, wherein the adjusted transmit power request is a request to increase transmit power or a request to decrease transmit power.

Aspect 52. The method of any one of Aspects 50 or 51, wherein the adjusted waveform type request is a request for a multi-sine input RF signal waveform or a request for an assigned sine signal input RF signal waveform.

Aspect 53. The method of any one of Aspects 50 to 52, further comprising: transmitting, to the energy harvesting device, a second input RF signal, wherein a power of the second input RF signal is associated with the adjusted transmit power request.

Aspect 54. The method of any one of Aspects 50 to 53, wherein the adjusted transmit power request is indicated based on a pre-determined sequence, wherein the pre-determined sequence is determined based on the energy status reporting configuration.

Aspect 55. A non-transitory computer-readable medium having stored thereon instructions that, when executed by one or more processors, cause the one or more processors to perform operations according to any of Aspects 17 to 32.

Aspect 56. An apparatus comprising one or more means for performing operations according to any of Aspects 17 to 32.

Aspect 57. A non-transitory computer-readable medium having stored thereon instructions that, when executed by one or more processors, cause the one or more processors to perform operations according to any of Aspects 44 to 54.

Aspect 58. An apparatus comprising one or more means for performing operations according to any of Aspects 44 to 54.

1. An energy harvesting device for wireless communications, comprising:
at least one memory; and
at least one processor coupled to the at least one memory, the at least one processor configured to:
receive, from a network device, an energy status reporting configuration;
receive, from the network device, an input radio frequency (RF) signal; and
transmit, to the network device, energy status information indicative of energy harvesting associated with the energy harvesting device based on the input RF signal.

2. The energy harvesting device of claim 1, wherein the energy status information is indicative of at least one of a conversion efficiency associated with a rectifier included in an energy harvester of the energy harvesting device, an input power associated with the rectifier, an output power associated with the rectifier, or an operating zone of the rectifier.

3. The energy harvesting device of claim 1, wherein:
the energy status reporting configuration is indicative of an energy status measurement window and a reporting format associated with the energy status measurement window; and
the at least one processor is configured to generate the energy status information using the energy status measurement window and the reporting format.

4. The energy harvesting device of claim 1, wherein the energy status information is indicative of at least one of a stored energy associated with the energy harvesting device or an energy headroom associated with the energy harvesting device.

5. The energy harvesting device of claim 4, wherein:
the energy status reporting configuration is indicative of one or more energy status reporting thresholds; and
the at least one processor is configured to transmit the energy status information based on a determination that at least one of the stored energy or the energy headroom is less than at least one of the one or more energy status reporting thresholds.

6. The energy harvesting device of claim 4, wherein the at least one processor is further configured to:
determine the energy headroom based on a difference between the stored energy associated with the energy harvesting device and a maximum energy associated with the energy harvesting device.

7. The energy harvesting device of claim 6, wherein the at least one processor is further configured to:
determine an instantaneously harvested energy obtained from the input RF signal using an energy harvester included in the energy harvesting device; and
determine the energy headroom further based on at least one of the instantaneously harvested energy or an energy harvesting efficiency associated with the energy harvester.

8. The energy harvesting device of claim 7, wherein the energy status reporting configuration includes one or more parameters for determining the instantaneously harvested energy obtained from the input RF signal.

9. The energy harvesting device of claim 1, wherein:
the energy status reporting configuration is indicative of a periodic reporting interval; and
the at least one processor is configured to transmit the energy status information based on the periodic reporting interval.

10. The energy harvesting device of claim 1, wherein, to transmit the energy status information, the at least one processor is configured to:
receive, from the network device, an energy status reporting trigger indicative of one or more energy status conditions;
compare a current energy status of the energy harvesting device to the one or more energy status conditions; and
transmit, to the network device, the energy status information based on the energy status reporting trigger.

11. The energy harvesting device of claim 10, wherein the energy status reporting trigger is an aperiodic reporting trigger or a semi-persistent reporting trigger.

12. The energy harvesting device of claim 1, wherein the energy status information is indicative of at least one of an adjusted transmit power request associated with the input RF signal or an adjusted waveform type request associated with the input RF signal.

13. The energy harvesting device of claim 12, wherein the adjusted transmit power request is a request to increase transmit power or a request to decrease transmit power.

14. The energy harvesting device of claim 12, wherein the adjusted waveform type request is a request for a multi-sine input RF signal waveform or a request for an assigned sine signal input RF signal waveform.

15. The energy harvesting device of claim 12, wherein the at least one processor is further configured to:
receive, from the network device, a second input RF signal, wherein a power of the second input RF signal is associated with the adjusted transmit power request.

16. The energy harvesting device of claim 12, wherein the adjusted transmit power request is indicated based on a pre-determined sequence, wherein the pre-determined sequence is determined based on the energy status reporting configuration.

17. A method of wireless communications performed at an energy harvesting device, the method comprising:
receiving, at the energy harvesting device from a network device, an energy status reporting configuration;
receiving, at the energy harvesting device from the network device, an input radio frequency (RF) signal; and
transmitting, from the energy harvesting device to the network device, energy status information indicative of energy harvesting associated with the energy harvesting device based on the input RF signal.

18-30. (canceled)

31. A network device for wireless communications, comprising:
at least one memory; and
at least one processor coupled to the at least one memory, the at least one processor configured to:
transmit, to an energy harvesting device, an energy status reporting configuration;
transmit, to the energy harvesting device, an input radio frequency (RF) signal; and
receive, from the energy harvesting device, energy status information indicative of energy harvesting associated with the energy harvesting device based on the input RF signal.

32. The network device of claim 31, wherein the energy status information is indicative of at least one of a conversion efficiency associated with a rectifier included in an energy harvester of the energy harvesting device, an input power associated with the rectifier, an output power associated with the rectifier, an operating zone of the rectifier, or an energy headroom associated with the energy harvesting device.

33. The network device of claim 31, wherein the energy status reporting configuration is indicative of an energy status measurement window and a reporting format for the energy status information.
